(19) United States
(12) Patent Application Publication
(10) Pub. No.: US 2024/0182626 A1
(43) Pub. Date: Jun. 6, 2024

(54) PROCESS FOR PREPARATION OF A CARBODIIMIDE AND/OR A POLYCARBODIIMIDE

(71) Applicant: BASF SE, Ludwigshafen am Rhein (DE)

(72) Inventors: Frederic Lucas, Ludwigshafen am Rhein (DE); Tobias Gienau, Waterloo (BE); Stephan Dohmen, Lemfoerde (DE); Lennart Karl Bernhard Garve, Ludwigshafen am Rhein (DE); Frank Schaefer, Lemfoerde (DE)

(73) Assignee: BASF SE, Ludwigshafen am Rhein (DE)

(21) Appl. No.: 18/555,434

(22) PCT Filed: Apr. 14, 2022
(86) PCT No.: PCT/EP2022/059994

§ 371 Date: Oct. 13, 2023

(30) Foreign Application Priority Data
Apr. 16, 2021 (EP) 21168795.9

(51) Int. Cl. C08G 18/09; C08G 18/18; C08G 18/48

(52) U.S. Cl. CPC C08G 18/095; C08G 18/1875; C08G 18/4833

(57) ABSTRACT

A process can be used for the preparation of a carbodiimide and/or a polycarbodiimide, where the process is particularly essentially free of an alkali metal. The carbodiimide and/or polycarbodiimide obtained and/or obtainable by the process and uses thereof are also provided.

### TECHNICAL FIELD

The present invention relates to a process for the preparation of a carbodiimide and/or a polycarbodiimide, the process being in particular essentially free of an alkali metal. Further, the pre sent invention relates to a carbodiimide and/or a polycarbodiimide, obtained and/or obtainable by the inventive process, and use thereof.

### INTRODUCTION

Carbodiimides and polycarbodiimides are known compounds, which are used as stabilizers in plastics, in particular with respect to undesired degradation due to hydrolysis. In the context of the present invention the term polycarbodiimides includes oligomeric as well as polymeric forms thereof. For example, in particular thermoplastic polyurethanes are typically stabilized with polycarbodiimides.

Generally, carbodiimides and also polycarbodiimides can be prepared by known methods, especially by elimination of carbon dioxide from monoisocyanates or polyisocyanates under catalytic conditions. In particular, two diisocyanates can react in an elimination reaction to a carbodiimide. Further elimination reaction can lead to polycarbodiimides of the formula (I):

O═C═N-[Q-N═C═N]ₙ-Q-N═C═O (I)

wherein n is typically in the range of from 2 to 500, preferably 3 to 20, more preferably 4 to 10, and wherein Q represents an organic backbone.

Said carbodiimidization reaction is typically run in the presence of a catalyst. Suitable catalysts include heterocyclic compounds containing phosphorus, e. g. phospholines, phospholenes and phospholidines and also their oxides and sulfides and/or metal carbonyls. Typical catalysts include phospholene oxides, in particular 1-methyl-2-phospholene-1-oxide or 3-Methyl-1-phenyl-2-phospholene 1-oxide.

For example, a typical hydrolysis stabilizer for thermoplastic polyurethanes (Elastostab) can be synthesized from tetramethylxylene diisocyanate (TMXDI) and homogenously catalyzed by 1-methyl-2-phospholene-1-oxide (MPO). In particular, the used phospholene oxide-containing catalyst is comparatively expensive and it has to be removed from the end-product, typically via distillation, in order to avoid any side reaction when formulated in thermoplastic polyurethanes.

U.S. Pat. No. 3,345,407 A relates to catalysts for the preparation of bis-(2,6-diethylphenyl)carbodiimides. In this regard, alkali metal tertiary alkoxides and alkali metal 2,6-di(tert.-alkyl)phenoxides are disclosed. In the examples, use of potassium tert.-butoxide, lithium tert.-butoxide, and sodium 2,6-di(tert.-butyl)-4-methyl phenolate are disclosed as catalysts.

U.S. Pat. No. 6,184,410 B1 relates to carbodiimides based on 1,3-bis-(1-methyl-1-isocyanatoethyl)benzene, in particular containing from 12 to 40% by weight of ethylene oxide units. As catalyst for preparation thereof, 1-methyl-2-phospholene 1-oxide is used. Further disclosed is the possibility to further react a carbodiimide with for example hydroxyl, thiol, primary amino and/or secondary amino groups.

WO 2016/202781 A1 also relates to the preparation of polymeric carbodiimides whereby basic cesium salts are used as catalytic compound. It is disclosed that separation of the used cesium salts is performed via filtration or extraction by means of a solvent, e. g. water and/or an alcohol.

EP 3766863 A1 relates to a method for producing a carbodiimide compound by reacting an aliphatic tertiary isocyanate compound in the presence of an organic alkali metal compound having Lewis basicity. The disclosed method avoids use of phosphorous containing compounds as catalyst. Instead alkali metal compounds are used which can be separated from the reaction mixture for obtaining the desired carbodiimide.

Thus, a need remains for a process for the production of carbodiimides and/or polycarbodiimides avoiding the disadvantages of known processes, in particular with respect to re source and process efficiency. Further, the need remains for a process being comparatively simplified, which avoids using potentially harmful materials, and avoids using materials which must be separated from the obtained reaction mixture before further processing of the carbodiimiden and/or the polycarbodiimide.

### DETAILED DESCRIPTION

It was an object of the present invention to provide an improved process for the preparation of carbodiimides and/or polycarbodiimides, in particular avoiding the draw-backs of known processes. Thus, it was an object of the present invention to provide an improved process for the preparation of carbodiimides and/or polycarbodiimides being particularly simplified, thus, comprising less process steps, in particular avoiding an expensive separation of the catalyst. Also, it was an object to provide such a process under reaction conditions allowing comparatively low temperatures while achieving excellent yields.

It has surprisingly been found that the used compounds are suitable for catalyzing the carbodiimidization of tertiary isocyanates, in particular the carbodiimidization of tertiary diisocyanates, to carbodiimides and/or polycarbodiimides, while showing a higher catalytic activity than catalysts from the prior art. All the more surprising, the used compounds exhibit a higher activity even at comparatively low temperatures. Especially considering the opportunity to perform carbodiimidization reactions at lower temperatures than disclosed in the prior art allows a simplification of the preparation process. In this regard, an advantage of simplification is that the catalytic compound does not have to be removed from the reaction mixture, e. g. by tedious filtration. Instead, the reaction mixture can be subjected to conditions where the catalytic compound decomposes to gaseous by-products, which may be easily separated.

The carbodiimides and polycarbodiimides of the present invention display a high hydrolysis inhibition action and light stability. Further, the carbodiimides and polycarbodiimides have good compatibility with the polyaddition and polycondensation products containing ester groups, in particular with polyester urethane rubbers, and can also be homogeneously mixed with these materials in the melt without problems.

The carbodimides and polycarbodiimides of the present invention are very suitable as acceptor for carboxyl compounds and are therefore preferably used as stabilizers against hydrolytic degradation of compounds containing ester groups, for example polymers containing ester groups, e. g. polycondensation products such as thermoplastic polyesters such as polyethylene terephthalate and polybutylene terephthalate, polyether esters, polyamides, polyesteramides, polycaprolactones and also unsaturated polyester resins and polyester esters, e. g. block copolymers of polyethylene terephthalate or polybutylene terephthalate and polycaprolactone, and polyaddition products, e. g. polyurethanes, polyureas and polyurethane-polyurea elastomers containing ester groups.

Owing to their good solubility in the formative components for preparing polyurethanes and their good compatibility with the polyurethanes formed, the carbodiimides and polycarbodiimides of the present invention are particularly suitable as stabilizers against hydrolytic degradation of polyurethanes, preferably compact or cellular polyurethane elastomers and in particular thermoplastic polyurethanes, and also cellulose or compact elastomers.

Therefore, the present invention relates to a process for the preparation of a carbodiimide and/or a polycarbodiimide, preferably for the preparation of a polycarbodiimide, the process comprising
(i) providing a mixture comprising one or more tertiary isocyanates and a catalytic compound;
   wherein the catalytic compound comprises a cation [R¹R²R³R⁴X]⁺,
   wherein in the cation X═N or P,
   wherein R¹, R², R³, and R⁴ in the cation independently from one another is an optionally branched and/or optionally cyclic and/or optionally substituted alkyl, alkaryl, aralkyl, or aryl, wherein R¹ and R² optionally form an optionally heteroatom-containing ring, wherein the heteroatom is preferably NR²⁷, O or S, wherein R²⁷ is H or alkyl, wherein R¹, R² and R³ optionally form two rings;
   wherein the mixture obtained in (i) comprises equal to or less than 1.75 mol-% of an alkali metal, calculated as elemental alkali metal, based on 100 mol-% of the one or more tertiary isocyanates, calculated as sum of the molar amounts of the one or more tertiary isocyanates;
(ii) subjecting the mixture obtained in (i) to reaction conditions in a gas atmosphere, wherein the reaction conditions comprise heating the reaction mixture at a temperature in the range of from 45 to 220° C.;
   to obtain a mixture comprising the carbodiimide and/or polycarbodiimide, preferably a mixture comprising the polycarbodiimide.

It is preferred that the mixture obtained in (i) of the process comprises equal to or less than 1.50 mol-%, preferably equal to or less than 1.00 mol-%, more preferably equal to or less than 0.60 mol-%, preferably equal to or less than 0.50 mol-%, more preferably equal to or less than 0.40 mol-%, more preferably equal to or less than 0.30 mol-%, more preferably equal to or less than 0.20 mol-%, more preferably equal to or less than 0.10 mol-%, more preferably equal to or less than 0.09 mol-%, more preferably equal to or less than 0.08 mol-%, more preferably equal to or less than 0.07 mol-%, more preferably equal to or less than 0.06 mol-%, more preferably equal to or less than 0.05 mol-%, more preferably equal to or less than 0.04 mol-%, more preferably equal to or less than 0.03 mol-%, more preferably equal to or less than 0.02 mol-%, more preferably equal to or less than 0.01 mol-%, more preferably equal to or less than 0.001 mol-%, of an alkali metal, calculated as elemental alkali metal, based on 100 mol-% of the one or more tertiary isocyanates, calculated as sum of the molar amounts of the one or more tertiary isocyanates, wherein the mixture obtained in (i) is more preferably essentially free of an alkali metal.

It is preferred that the mixture obtained in (i) of the process comprises equal to or less than 1.75 mol-%, preferably equal to or less than 1.50 mol-%, more preferably equal to or less than 1.00 mol-%, more preferably equal to or less than 0.60 mol-%, preferably equal to or less than 0.50 mol-%, more preferably equal to or less than 0.40 mol-%, more preferably equal to or less than 0.30 mol-%, more preferably equal to or less than 0.20 mol-%, more preferably equal to or less than 0.10 mol-%, more preferably equal to or less than 0.09 mol-%, more preferably equal to or less than 0.08 mol-%, more preferably equal to or less than 0.07 mol-%, more preferably equal to or less than 0.06 mol-%, more preferably equal to or less than 0.05 mol-%, more preferably equal to or less than 0.04 mol-%, more preferably equal to or less than 0.03 mol-%, more preferably equal to or less than 0.02 mol-%, more preferably equal to or less than 0.01 mol-%, more preferably equal to or less than 0.001 mol-%, of Mg, calculated as elemental Mg, preferably of Mg and/or Ca, calculated as elemental Mg and elemental Ca, respectively, more preferably of one or more of Mg, Ca, and Ba, calculated as elemental Mg, as elemental Ca and elemental Ba, respectively, more preferably of one or more of an alkali earth metal, calculated as elemental alkali earth metal, based on 100 mol-% of the one or more tertiary isocyanates, calculated as sum of the molar amounts of the one or more tertiary isocyanates, wherein the mixture obtained in (i) more preferably is essentially free of Mg, more preferably of Mg and/or Ca, more preferably of one or more of Mg, Ca, and Ba, more preferably of one or more of an alkali earth metal.

It is preferred that X═N in the cation comprised in the catalytic compound comprised in the mixture according to (i) of the process, and wherein the mixture obtained in (i) comprises equal to or less than 5 mol-%, preferably equal to or less than 2.5 mol-%, more preferably equal to or less than 2.0 mol-%, more preferably equal to or less than 1.5 mol-%, more preferably equal to or less than 1.0 mol-%, more preferably equal to or less than 0.7 mol-%, more preferably equal to or less than 0.5 mol-%, more preferably equal to or less than 0.2 mol-%, more preferably equal to or less than 0.1 mol-%, more preferably equal to or less than 0.05 mol-%, more preferably equal to or less than 0.02 mol-%, more preferably equal to or less than 0.01 mol-%, of a compound comprising a phosphorous oxygen double bond, calculated as molar amount of the compound comprising a phosphorous oxygen double bond, preferably of a phospholene oxide, calculated as molar amount of the phospholene oxide, more preferably of a compound comprising P, calculated as molar amount of the compound comprising P, more preferably of P, calculated as elemental P, based on 100 mol-% of the one or more tertiary isocyanates, calculated as sum of the molar amounts of the one or more tertiary isocyanates, wherein the mixture obtained in (i) more preferably is essentially free of a compound comprising a phosphorous oxy gen double bond, preferably of a phospholene oxide, more preferably of a compound comprising P, and more preferably of P.

It is preferred that the catalytic compound comprised in the mixture according to (i) of the process comprises one or more of a hydroxide anion and a carboxylate anion [R⁵—COO]⁻, wherein the catalytic compound preferably comprises a carboxylate anion [R⁵—COO]⁻, wherein R⁵ in the carboxylate anion is hydroxyl (OH) or an optionally branched and/or optionally substituted (C₁-C₁₂)alkyl, wherein R⁵ in the carboxylate anion preferably is hydroxyl (OH) or an optionally branched (C₁-C₁₂)alkyl.

According to a first alternative, it is preferred that the catalytic compound comprised in the mixture according to (i) of the process comprises a hydroxide anion.

In the case where the catalytic compound comprised in the mixture according to (i) of the process comprises a hydroxide anion, it is preferred that from 95 to 100 weight-%, preferably from 99 to 100 weight-%, more preferably from 99.9 to 100 weight-%, of the catalytic compound comprised in the mixture according to (i) consists of the cation [R¹R²R³R⁴X]⁺ and the hydroxide anion, wherein the catalytic compound more preferably essentially consists of the cation [R¹R²R³R⁴X]⁺ and the hydroxide anion.

According to a second alternative, it is preferred that the catalytic compound comprised in the mixture according to (i) of the process comprises a carboxylate anion [R⁵—COO]⁻, wherein R⁵ in the carboxylate anion is hydroxyl (OH) or an optionally branched and/or optionally substituted (C₁-C₁₂)alkyl, wherein R⁵ in the carboxylate anion preferably is hydroxyl (OH) or an optionally branched (C₁-C₁₂)alkyl.

In the case where the catalytic compound comprises a carboxylate anion [R⁵—COO]⁻, wherein R⁵ in the carboxylate anion is hydroxyl (OH) or an optionally branched and/or optionally substituted (C₁-C₁₂)alkyl, wherein R⁵ in the carboxylate anion preferably is hydroxyl (OH) or an optionally branched (C₁-C₁₂)alkyl, it is preferred that from 95 to 100 weight-%, preferably from 99 to 100 weight-%, more preferably from 99.9 to 100 weight-%, of the catalytic compound comprised in the mixture according to (i) consists of the cation [R¹R²R³R⁴X]⁺ and the carboxylate anion [R⁵—COO]⁻, wherein the catalytic compound more preferably essentially consists of the cation [R¹R²R³R⁴X]⁺ and the carboxylate anion [R⁵—COO]⁻.

Further in the case where the catalytic compound comprises a carboxylate anion [R⁵—COO]⁻, wherein R⁵ in the carboxylate anion is hydroxyl (OH) or an optionally branched and/or optionally substituted (C₁-C₁₂)alkyl, wherein R⁵ in the carboxylate anion preferably is hydroxyl (OH) or an optionally branched (C₁-C₁₂)alkyl, it is preferred that R⁵ of the carboxylate anion [R⁵—COO]⁻ preferably is alkyl or phenyl,
wherein R⁵ of the carboxylate anion [R⁵—COO]⁻ more preferably is, optionally branched, more preferably linear, (C₁-C₂₂)alkyl, preferably (C₁-C₁₆)alkyl, more preferably (C₁-C₁₂)alkyl, more preferably (C₁-C₈)alkyl, more preferably (C₁-C₆)alkyl, more preferably (C₁-C₅)alkyl, more preferably (C₁-C₄)alkyl, more preferably (C₁-C₂)alkyl,
wherein R⁵ of the carboxylate anion [R⁵—COO]⁻ more preferably is selected from the group consisting of methyl, ethyl, propyl, iso-propyl, tert-butyl, iso-butyl, sec-butyl, n-butyl, n-pentyl, 2-methylbutan-2-yl (tert-pentyl), 2,2-dimethylpropyl (neo-pentyl), 3-methylbutyl (iso-pentyl), pentan-2-yl (sec-pentyl), pentan-3-yl, 3-methylbutan-2-yl, 2-methylbutyl, hexyl, 1,1-dimethyl-butyl, heptyl, 2-methyl-2-ethyl-butyl, 2,2-dimethyl-pentyl, 1-ethyl-pentyl, octyl, 1-ethylhexyl, nonyl, decyl, lauryl, myristyl, cetyl, stearyl, phenyl, para-tert-butyl-phenyl, para-methyl-phenyl, and ortho-methyl-phenyl,
wherein R⁵ of the carboxylate anion [R⁵—COO]⁻ more preferably is selected from the group consisting of methyl, ethyl, and 1-ethyl-pentyl.

Further in the case where the catalytic compound comprises a carboxylate anion [R⁵—COO]⁻, wherein R⁵ in the carboxylate anion is hydroxyl (OH) or an optionally branched and/or optionally substituted (C₁-C₁₂)alkyl, wherein R⁵ in the carboxylate anion preferably is hydroxyl (OH) or an optionally branched (C₁-C₁₂)alkyl, it is preferred that the (C₁-C₁₂)alkyl is substituted, wherein the substituted (C₁-C₁₂)alkyl comprises one or more substituents, wherein the one or more substituents of the substituted (C₁-C₁₂)alkyl are preferably selected from the group consisting of (C₁-C₃)alkoxy, hydroxyl, amino, halides, and combinations of two or more thereof, more preferably from the group consisting of (C₁-C₂)alkoxy, hydroxyl, amino, chloro, bromo, fluoro, and combinations of two or more thereof, more preferably from the group consisting of hydroxyl, amino, chloro, and combinations thereof, wherein more preferably the one or more substituents is hydroxyl.

Further in the case where the catalytic compound comprises a carboxylate anion [R⁵—COO]⁻, wherein R⁵ in the carboxylate anion is hydroxyl (OH) or an optionally branched and/or optionally substituted (C₁-C₁₂)alkyl, wherein R⁵ in the carboxylate anion preferably is hydroxyl (OH) or an optionally branched (C₁-C₁₂)alkyl, it is preferred that the (C₁-C₁₂)alkyl is substituted, wherein the substituted (C₁-C₁₂)alkyl comprises one or more optional substituents, wherein the substituted (C₁-C₁₂)alkyl preferably comprises 1 to 4 substituents, more preferably 1 to 3 substituents, more preferably 1 or 2 substituents, wherein the substituted (C₁-C₁₂)alkyl more preferably comprises 1 substituent.

Further in the case where the catalytic compound comprises a carboxylate anion [R⁵—COO]⁻, wherein R⁵ in the carboxylate anion is hydroxyl (OH) or an optionally branched and/or optionally substituted (C₁-C₁₂)alkyl, wherein R⁵ in the carboxylate anion preferably is hydroxyl (OH) or an optionally branched (C₁-C₁₂)alkyl, it is preferred that the carboxylate anion [R⁵—COO]⁻ comprised in the catalytic compound comprised in the mixture according to (i) is selected from the group consisting of acetate, propionate, 2-ethylhexanoate, adipate, benzoate, oxalate, and a mixture of two or more thereof,
wherein the carboxylate anion [R⁵—COO]⁻ preferably is acetate or 2-ethylhexanoate.

According to a first alternative, it is preferred that X═P in the cation comprised in the catalytic compound comprised in the mixture according to (i) of the process.

According to a second alternative, it is preferred that X═N in the cation comprised in the catalytic compound comprised in the mixture according to (i) of the process.

It is preferred that R¹, R², R³, and R⁴ in the cation comprised in the catalytic compound comprised in the mixture according to (i) of the process independently from one another is selected from the group consisting of optionally branched and/or optionally cyclic, preferably linear, and/or optionally substituted (C₁-C₂₂)alkyl, cycloaliphatic (C₅-C₂₀)alkyl, (C₆-C₁₈)aryl, (C₇-C₂₀)aralkyl, and (C₇-C₂₀)alkaryl,
preferably selected from the group consisting of optionally branched and/or optionally cyclic,
preferably linear, and/or optionally substituted (C₁-C₁₆)alkyl, cycloaliphatic (C₅-C₁₀)alkyl, (C₆-C₁₈)aryl, (C₇-C₂₀)aralkyl, and (C₇-C₂₀)alkaryl,
more preferably selected from the group consisting of optionally branched and/or optionally cyclic, preferably linear, and/or optionally substituted (C₁-C₁₂)alkyl, cycloaliphatic (C₅-C₁₀)alkyl, (C₆-C₉)aryl, (C₇-C₁₅)aralkyl, and (C₇-C₁₅)alkaryl,
more preferably selected from the group consisting of optionally branched and/or optionally cyclic, preferably linear, and/or optionally substituted (C₁-C₈)alkyl, cycloaliphatic (C₅-C₆)alkyl, (C₆-C₉)aryl, (C₇-C₁₂)aralkyl, and (C₇-C₁₂)alkaryl,
more preferably selected from the group consisting of optionally branched and/or optionally cyclic, preferably linear, and/or optionally substituted (C₁-C₆)alkyl, cycloaliphatic (C₅-C₆)alkyl, and (C₆)aryl,
more preferably selected from the group consisting of optionally branched and/or optionally cyclic, preferably linear, and/or optionally substituted (C₁-C₅)alkyl,
more preferably selected from the group consisting of optionally branched and/or optionally cyclic, preferably linear, and/or optionally substituted (C₁-C₄)alkyl,
wherein preferably R¹, R², R³, and R⁴ in the cation independently from one another is, optionally substituted, methyl, ethyl, propyl, isopropyl, n-butyl, sec-butyl, isobutyl, or tert-butyl, wherein more preferably R¹ in the cation is, optionally substituted, methyl or n-butyl, and R², R³, and R⁴ in the cation independently from one another is, optionally substituted, methyl, ethyl, propyl, isopropyl, n-butyl, sec-butyl, isobutyl, or tert-butyl,
wherein more preferably R¹ in the cation is, optionally substituted, methyl and R², R³, and R⁴ in the cation independently from one another is, optionally substituted, methyl or n-butyl, wherein more preferably R¹, R², R³, and R⁴ in the cation independently from one another is, optionally substituted, methyl or n-butyl,
wherein R¹ and R² preferably form an optionally heteroatom-containing ring, wherein the heteroatom is preferably NR²⁷, O or S, more preferably O, wherein R²⁷ is preferably H, methyl, ethyl, propyl, isopropyl, n-butyl, tert-butyl, or isobutyl, more preferably methyl, wherein R¹, R² and R³ preferably form two rings.

It is preferred that R¹, R², and R³ in the cation comprised in the catalytic compound comprised in the mixture according to (i) of the process independently from one another is optionally substituted alkyl,
wherein R¹, R², and R³ in the cation independently from one another preferably is, optionally branched, preferably linear, and/or optionally substituted (C₁-C₂₂)alkyl, preferably (C₁-C₁₆)alkyl, more preferably (C₁-C₁₂)alkyl, more preferably (C₁-C₈)alkyl, more preferably (C₁-C₆)alkyl, more preferably (C₁-C₅)alkyl, more preferably (C₁-C₄)alkyl,
wherein R¹, R², and R³ in the cation independently from one another more preferably is, optionally substituted, methyl, ethyl, propyl, isopropyl, n-butyl, sec-butyl, isobutyl, or tert-butyl,
wherein R¹, R², and R³ in the cation independently from one another more preferably is, option ally substituted, methyl or n-butyl,
and wherein R⁴ in the cation is, optionally substituted, benzyl or phenyl.

It is preferred that one or more of R¹, R², R³, and R⁴ in the cation comprised in the catalytic compound comprised in the mixture according to (i) of the process are substituted, wherein the one or more optional substituents of the one or more substituted R¹, R², R³, and R⁴ are preferably selected from the group consisting of (C₁-C₃)alkoxy, hydroxyl, amino, halides, and combinations of two or more thereof, more preferably from the group consisting of (C₁-C₂)alkoxy, hydroxyl, amino, chloro, bromo, fluoro, and combinations of two or more thereof, more preferably from the group consisting of hydroxyl, amino, chloro, and combinations thereof, wherein more preferably the one or more optional substituents is hydroxyl.

It is preferred that one or more of R¹, R², R³, and R⁴ in the cation comprised in the catalytic compound comprised in the mixture according to (i) of the process are substituted, wherein the one or more substituted R¹, R², R³, and R⁴ independently from each other comprise one or more substituents, wherein the one or more substituted R¹, R², R³, and R⁴ independently from each other preferably comprises 1 to 4 substituents, more preferably 1 to 3 substituents, more preferably 1 or 2 substituents, wherein the one or more substituted R¹, R², R³, and R⁴ independently from each other more preferably comprise 1 substituent.

It is preferred that X═N in the cation comprised in the catalytic compound comprised in the mixture according to (i) of the process, wherein the cation comprised in the catalytic compound comprised in the mixture according to (i) is selected from the group consisting of tetramethylammonium, tetraethylammonium, tetrapropylammonium, tri-n-butylmethylammonium, tri-n-butylethylammonium, tetra-n-butylammonium, benzyltrimethylammonium, benzyltriethylammonium, benzyltri-n-butylammonium, benzyldimethyloctylammonium, benzyldimethyldecylammonium, benzyldimethyldodecylammonium, methyltriethylammonium, phenyltrimethylammonium, behentrimonium, cetyltrimethylammonium, cetalkonium, cetyldimethylbenzylammonium, cetyldimethylethylammonium, cetrimide, didecyldimethylammonium, decyltrimethylammonium, dodecyltrimethylammonium, myristyltrimethylammonium, methyltrioctylammonium, stearyltrimethylammonium, stearyltributylammonium, tetraoctylammonium, trimethyloctylammonium, trioctylmethylammonium, diisopropyldiethylammonium, diisopropylethylmethylammonium, diisopropylethylbenzylammonium, N,N-dimethylpiperidinium, N,N-dimethylmorpholinium, N,N-dimethylpiperazinium or N-methyldiazabicyclo[2.2.2]octane, 2-hydroxyethyl trimethylammonium, 2-hydroxypropyl trimethylammonium, 2-hydroxyethyl triethylammonium, 2-hydroxypropyl triethylammonium, 2-hydroxyethyl tri-n-butylammonium, 2-hydroxypropyl tri-n-butylammonium, 2-hydroxyethyl dimethyl benzyl ammonium, 2-hydroxypropyl dimethyl benzyl ammonium, 2-hydroxyethyl trimethylammonium, 2-hydroxypropyl trimethylammonium, 2-hydroxyethyl dimethyl benzyl ammonium, N-(2-hydroxyethyl)-N-methyl morpholinium, N-(2-hydroxypropyl)-N-methyl morpholinium, N,N-dimethylmorpholinium, N,N-dimethylpiperidinium, N,N-dimethylpiperazinium, N-methyldiazabicyclo[2.2.2]octane, 3-hydroxy quinuclidine, 3-hydroxy quinuclidine, and a mixture of two or more thereof,
wherein the cation preferably is selected from the group consisting of tetramethylammonium, tri-n-butylmethylammonium, tetra-n-butylammonium, and a mixture of two or more thereof, wherein the cation more preferably is tetramethylammonium, tetra-n-butylammonium or tri-n-butylmethylammonium.

It is preferred that the one or more tertiary isocyanates comprised in the mixture according to (i) of the process comprises, preferably consists of, one or more tertiary monoisocyanates, preferably of a tertiary monoisocyanate, one or more tertiary diisocyanates, preferably a tertiary diisocyanate, or a mixture thereof.

In the case where the one or more tertiary isocyanates comprised in the mixture according to (i) of the process comprises, preferably consists of, one or more tertiary monoisocyanates, preferably of a tertiary monoisocyanate, one or more tertiary diisocyanates, preferably a tertiary diisocyanate, or a mixture thereof, it is preferred that the isocyanate group of each of the one or more tertiary monoisocyanates is bound to a tertiary carbon atom.

Further in the case where the one or more tertiary isocyanates comprised in the mixture according to (i) of the process comprises, preferably consists of, one or more tertiary monoisocyanates, preferably of a tertiary monoisocyanate, one or more tertiary diisocyanates, preferably a tertiary diisocyanate, or a mixture thereof, it is preferred that each of the two isocyanate groups of the one or more tertiary diisocyanates is bound to a tertiary carbon atom.

the case where the one or more tertiary isocyanates comprised in the mixture according to (i) of the process comprises, preferably consists of, one or more tertiary monoisocyanates, preferably of a tertiary monoisocyanate, one or more tertiary diisocyanates, preferably a tertiary diisocyanate, or a mixture thereof, it is preferred that the one or more tertiary diisocyanates comprises, preferably consists of, a tertiary diisocyanate having the formula (II):

OCN—C(R⁶,R⁷)—R⁸—C(R⁹,R¹⁰)—NCO (II),
wherein R⁶, R⁷, R⁹ and R¹⁰ independently from one another is alkyl,
wherein R⁶, R⁷, R⁹ and R¹⁰ independently from one another preferably is, optionally branched, preferably linear, (C₁-C₂₂)alkyl, preferably (C₁-C₁₆)alkyl, more preferably (C₁-C₁₂)alkyl, more preferably (C₁-C₈)alkyl, more preferably (C₁-C₆)alkyl, more preferably (C₁-C₅)alkyl, more preferably (C₁-C₄)alkyl,
wherein R⁶, R⁷, R⁹ and R¹⁰ independently from one another more preferably is methyl, ethyl, propyl, isopropyl, n-butyl, sec-butyl, isobutyl, or tert-butyl, more preferably methyl,
wherein R⁸ is an optionally branched and/or cyclic alkylene, alkarylene, aralkylene, or arylene,
wherein R⁸ is preferably selected from the group consisting of linear or branched (C₁-C₁₅)alkylene, cycloaliphatic (C₅-C₂₀)alkylene, (C₆-C₁₈)arylene, (C₇-C₂₀)aralkylene, and (C₇-C₂₀)alkarylene, preferably selected from the group consisting of (C₁-C₈)alkylene, cycloaliphatic (C₅-C₁₀)alkylene, (C₆-C₉)arylene, (C₇-C₁₅)aralkylene, and (C₇-C₁₅)alkarylene, more preferably selected from the group consisting of (C₁-C₆)alkylene, (C₅-C₆)alkylene, (C₆)arylene, (C₇-C₁₂)aralkylene, and (C₇-C₁₂)alkarylene, more preferably selected from the group consisting of (C₃-C₆)alkylene, (C₇-C₁₀)aralkylene, and (C₇-C₁₀)alkarylene, more preferably selected from the group consisting of (C₇-C₉)aralkylene, and (C₇-C₉)alkarylene, wherein R⁸ is more preferably selected from the group consisting of (C₈-C₉)aralkylene, and (C₈-C₉)alkarylene,
wherein R⁸ is more preferably selected from the group consisting of methylene, ethylene, trimethylene, tetramethylene, pentamethylene, hexamethylene, ortho-phenylene, meta-phenylene, and para-phenylene,
wherein R⁸ more preferably is selected from the group consisting of pentamethylene, hexamethylene, ortho-phenylene, meta-phenylene, and para-phenylene,
wherein R⁸ more preferably is para-phenylene.

It is preferred that the one or more tertiary isocyanates comprised in the mixture according to (i) of the process comprises, preferably consists of, a tertiary diisocyanate, preferably 1,3-bis(1-methyl-1-isocyanatoethyl)-benzene.

It is preferred that the one or more tertiary isocyanates comprised in the mixture according to (i) of the process comprises from 10 to 44 weight-%, preferably from 15 to 40 weight-%, more preferably from 32 to 37 weight-%, of NCO, based on 100 weight-% of the one or more tertiary isocyanates, calculated as sum of the weights of the one or more tertiary isocyanates.

In the case where the one or more tertiary isocyanates comprised in the mixture according to (i) of the process comprises, preferably consists of, one or more tertiary monoisocyanates, preferably of a tertiary monoisocyanate, one or more tertiary diisocyanates, preferably a tertiary diisocyanate, or a mixture thereof, it is preferred that the one or more tertiary monoisocyanates comprises, preferably consists of, a monoisocyanate having the formula (II):

OCN—C(R¹³,R¹⁴)—R¹⁵—C(R¹⁶,R¹⁷)—R¹⁸ (II),
wherein R¹³ and R¹⁴ independently from one another is alkyl,
wherein R¹³ and R¹⁴ independently from one another preferably is optionally branched, preferably linear, (C₁-C₂₂)alkyl, preferably (C₁-C₁₆)alkyl, more preferably (C₁-C₁₂)alkyl, more preferably (C₁-C₈)alkyl, more preferably (C₁-C₆)alkyl, more preferably (C₁-C₅)alkyl, more preferably (C₁-C₄)alkyl,
wherein R¹³ and R¹⁴ independently from one another more preferably is methyl, ethyl, propyl, isopropyl, n-butyl, sec-butyl, isobutyl, or tert-butyl, more preferably methyl,
wherein R¹⁶ and R¹⁷ independently from one another is H or alkyl,
wherein R¹⁶ and R¹⁷ independently from one another preferably is H or, optionally branched, preferably linear, (C₁-C₂₂)alkyl, preferably (C₁-C₁₆)alkyl, more preferably (C₁-C₁₂)alkyl, more preferably (C₁-C₈)alkyl, more preferably (C₁-C₆)alkyl, more preferably (C₁-C₅)alkyl, more preferably (C₁-C₄)alkyl,
wherein R¹⁶ and R¹⁷ independently from one another more preferably is H, methyl, ethyl, propyl, isopropyl, n-butyl, sec-butyl, isobutyl, or tert-butyl, more preferably methyl,
wherein R¹⁵ is an optionally branched and/or cyclic alkylene, alkarylene, aralkylene, or arylene,
wherein R¹⁵ is preferably selected from the group consisting of linear or branched (C₁-C₁₆)alkylene, cycloaliphatic (C₅-C₂₀)alkylene, (C₆-C₁₈)arylene, (C₇-C₂₀)aralkylene, and (C₇-C₂₀)alkarylene, preferably selected from the group consisting of (C₁-C₈)alkylene, cycloaliphatic (C₅-C₁₀)alkylene, (C₆-C₉)arylene, (C₇-C₁₅)aralkylene, and (C₇-C₁₅)alkarylene, more preferably selected from the group consisting of (C₁-C₆)alkylene, (C₅-C₆)alkylene, (C₆)arylene, (C₇-C₁₂)aralkylene, and (C₇-C₁₂)alkarylene, more preferably selected from the group consisting of (C₃-C₆)alkylene, (C₇-C₁₀)aralkylene, and (C₇-C₁₀)alkarylene, more preferably selected from the group consisting of (C₇-C₉)aralkylene, and (C₇-C₉)alkarylene, wherein R¹⁵ is more preferably selected from the group consisting of (C₈-C₉)aralkylene, and (C₈-C₉)alkarylene,
wherein R¹⁵ is more preferably selected from the group consisting of methylene, ethylene, trimethylene, tetramethylene, pentamethylene, hexamethylene, ortho-phenylene, meta-phenylene, and para-phenylene,
wherein R¹⁵ more preferably is selected from the group consisting of pentamethylene, hexamethylene, ortho-phenylene, meta-phenylene, and para-phenylene,
wherein R¹⁵ more preferably is para-phenylene, wherein R¹⁸ is selected from the group consisting of isopropenyl, NCNR¹⁹, NHCONHR²⁰, NHCONR²¹R²², and NHCOOR²³,
wherein R¹⁹ is (C₁-C₁₈)alkylene, (C₅-C₁₈)cycloalkylene, arylene, (C₇-C₁₈)alkarylene and/or (C₇-C₁₈)aralkylene, preferably (C₇-C₁₈)alkylarylene and/or (C₇-C₁₈)aralkylene,
wherein R²⁰, R²¹, R²², and R²³ independently from one another is selected from the group consisting of alkyl, cycloalkyl, alkaryl, aralkyl, a polyester group, a polyamide group, and —(CH₂)ₕ—O—[(CH₂)ₖ—O]_{g}—R²⁴,
wherein h is in the range of from 1 to 3, k is in the range of from 1 to 3, g is in the range of from 0 to 12, and wherein R²⁴ is H or (C₁-C₄)alkyl,
wherein R²⁰, R²¹, R²², and R²³ independently from one another is preferably selected from the group consisting of optionally branched and/or cyclic, preferably linear, (C₁-C₁₂)alkyl, cycloaliphatic (C₅-C₁₀)alkyl, (C₆-C₉)aryl, (C₇-C₁₅)aralkyl, and (C₇-C₁₅)alkaryl,
more preferably selected from the group consisting of optionally branched and/or cyclic, preferably linear, (C₁-C₈)alkyl, cycloaliphatic (C₅-C₆)alkyl, (C₆-C₉)aryl, (C₇-C₁₂)aralkyl, and (C₇-C₁₂)alkaryl,
more preferably selected from the group consisting of optionally branched and/or cyclic, preferably linear, (C₁-C₆)alkyl, cycloaliphatic (C₅-C₆)alkyl, and (C₆)aryl,
more preferably selected from the group consisting of optionally branched and/or cyclic, preferably linear, (C₁-C₅)alkyl,
more preferably selected from the group consisting of optionally branched and/or cyclic, preferably linear, (C₁-C₄)alkyl,
wherein preferably R²⁰, R²¹, R²², and R²³ independently from one another is methyl, ethyl, propyl, isopropyl, n-butyl, sec-butyl, isobutyl, or tert-butyl.

In the case where the one or more tertiary monoisocyanates comprises, preferably consists of, a monoisocyanate having the formula (II):

OCN—C(R¹³,R¹⁴)—R¹⁵—C(R¹⁶,R¹⁷)—R¹⁸ (II),
wherein R¹³ and R¹⁴ independently from one another is alkyl,
wherein R¹³ and R¹⁴ independently from one another preferably is optionally branched, preferably linear, (C₁-C₂₂)alkyl, preferably (C₁-C₁₆)alkyl, more preferably (C₁-C₁₂)alkyl, more preferably (C₁-C₈)alkyl, more preferably (C₁-C₆)alkyl, more preferably (C₁-C₅)alkyl, more preferably (C₁-C₄)alkyl,
wherein R¹³ and R¹⁴ independently from one another more preferably is methyl, ethyl, propyl, isopropyl, n-butyl, sec-butyl, isobutyl, or tert-butyl, more preferably methyl,
wherein R¹⁶ and R¹⁷ independently from one another is H or alkyl,
wherein R¹⁶ and R¹⁷ independently from one another preferably is H or, optionally branched, preferably linear, (C₁-C₂₂)alkyl, preferably (C₁-C₁₆)alkyl, more preferably (C₁-C₁₂)alkyl, more preferably (C₁-C₈)alkyl, more preferably (C₁-C₆)alkyl, more preferably (C₁-C₅)alkyl, more preferably (C₁-C₄)alkyl,
wherein R¹⁶ and R¹⁷ independently from one another more preferably is H, methyl, ethyl, propyl, isopropyl, n-butyl, sec-butyl, isobutyl, or tert-butyl, more preferably methyl,
wherein R¹⁵ is an optionally branched and/or cyclic alkylene, alkarylene, aralkylene, or arylene,
wherein R¹⁵ is preferably selected from the group consisting of linear or branched (C₁-C₁₆)alkylene, cycloaliphatic (C₅-C₂₀)alkylene, (C₆-C₁₈)arylene, (C₇-C₂₀)aralkylene, and (C₇-C₂₀)alkarylene, preferably selected from the group consisting of (C₁-C₈)alkylene, cycloaliphatic (C₅-C₁₀)alkylene, (C₆-C₉)arylene, (C₇-C₁₅)aralkylene, and (C₇-C₁₅)alkarylene, more preferably selected from the group consisting of (C₁-C₆)alkylene, (C₅-C₆)alkylene, (C₆)arylene, (C₇-C₁₂)aralkylene, and (C₇-C₁₂)alkarylene, more preferably selected from the group consisting of (C₃-C₆)alkylene, (C₇-C₁₀)aralkylene, and (C₇-C₁₀)alkarylene, more preferably selected from the group consisting of (C₇-C₉)aralkylene, and (C₇-C₉)alkarylene, wherein R¹⁵ is more preferably selected from the group consisting of (C₈-C₉)aralkylene, and (C₈-C₉)alkarylene,
wherein R¹⁵ is more preferably selected from the group consisting of methylene, ethylene, trimethylene, tetramethylene, pentamethylene, hexamethylene, ortho-phenylene, meta-phenylene, and para-phenylene,
wherein R¹⁵ more preferably is selected from the group consisting of pentamethylene, hexamethylene, ortho-phenylene, meta-phenylene, and para-phenylene,
wherein R¹⁵ more preferably is para-phenylene,
wherein R¹⁸ is selected from the group consisting of isopropenyl, NCNR¹⁹, NHCONHR²⁰, NHCONR²¹R²², and NHCOOR²³,
wherein R¹⁹ is (C₁-C₁₈)alkylene, (C₅-C₁₈)cycloalkylene, arylene, (C₇-C₁₈)alkarylene and/or (C₇-C₁₈)aralkylene, preferably (C₇-C₁₈)alkylarylene and/or (C₇-C₁₈)aralkylene,
wherein R²⁰, R²¹, R²², and R²³ independently from one another is selected from the group consisting of alkyl, cycloalkyl, alkaryl, aralkyl, a polyester group, a polyamide group, and —(CH₂)ₕ—O—[(CH₂)ₖ—O]_{g}—R²⁴,
wherein h is in the range of from 1 to 3, k is in the range of from 1 to 3, g is in the range of from 0 to 12, and wherein R²⁴ is H or (C₁-C₄)alkyl,
wherein R²⁰, R²¹, R²², and R²³ independently from one another is preferably selected from the group consisting of optionally branched and/or cyclic, preferably linear, (C₁-C₁₂)alkyl, cycloaliphatic (C₅-C₁₀)alkyl, (C₆-C₉)aryl, (C₇-C₁₅)aralkyl, and (C₇-C₁₅)alkaryl,
more preferably selected from the group consisting of optionally branched and/or cyclic, preferably linear, (C₁-C₈)alkyl, cycloaliphatic (C₅-C₆)alkyl, (C₆-C₉)aryl, (C₇-C₁₂)aralkyl, and (C₇-C₁₂)alkaryl,
more preferably selected from the group consisting of optionally branched and/or cyclic, preferably linear, (C₁-C₆)alkyl, cycloaliphatic (C₅-C₆)alkyl, and (C₆)aryl,
more preferably selected from the group consisting of optionally branched and/or cyclic, preferably linear, (C₁-C₅)alkyl,
more preferably selected from the group consisting of optionally branched and/or cyclic, preferably linear, (C₁-C₄)alkyl,
wherein preferably R²⁰, R²¹, R²², and R²³ independently from one another is methyl, ethyl, propyl, isopropyl, n-butyl, sec-butyl, isobutyl, or tert-butyl,
it is preferred that R²³ is O—(R²⁸—O)ₘ—R²⁹,
wherein R²⁸ is an alkylene group,
wherein R²⁸ is preferably selected from the group consisting of methylene, ethylene, trimethylene, tetramethylene, pentamethylene, hexamethylene, ortho-phenylene, meta-phenylene, para-phenylene,
wherein R²⁸ more preferably is ethylene,
wherein R²⁹ more preferably is, optionally branched, preferably linear, (C₁-C₂₂)alkyl, preferably (C₁-C₁₈)alkyl, more preferably partially unsaturated (C₁-C₁₈)alkyl, more preferably (C₁-C₁₆)alkyl, more preferably (C₁-C₁₂)alkyl, more preferably (C₁-C₈)alkyl, more preferably (C₁-C₆)alkyl, more preferably (C₁-C₅)alkyl, more preferably (C₁-C₄)alkyl,
wherein R²⁹ more preferably is methyl, ethyl, propyl, isopropyl, n-butyl, sec-butyl, isobutyl, or tert-butyl, more preferably methyl, and wherein m is an integer of 0 to 150, preferably an integer of 2 to 150, preferably an integer of 5 to 100, more preferably an integer of 7 to 50, more preferably an integer of 8 to 25, more preferably an integer of 9 to 20, more preferably an integer of 10 to 15.

In the case where R²³ is O—(R²⁸—O)ₘ—R²⁹,
wherein R²⁸ is an alkylene group,
wherein R²⁸ is preferably selected from the group consisting of methylene, ethylene, trimethylene, tetramethylene, pentamethylene, hexamethylene, ortho-phenylene, meta-phenylene, para-phenylene,
wherein R²⁸ more preferably is ethylene,
wherein R²⁹ more preferably is, optionally branched, preferably linear, (C₁-C₂₂)alkyl, preferably (C₁-C₁₈)alkyl, more preferably partially unsaturated (C₁-C₁₈)alkyl, more preferably (C₁-C₁₆)alkyl, more preferably (C₁-C₁₂)alkyl, more preferably (C₁-C₈)alkyl, more preferably (C₁-C₆)alkyl, more preferably (C₁-C₅)alkyl, more preferably (C₁-C₄)alkyl,
wherein R²⁹ more preferably is methyl, ethyl, propyl, isopropyl, n-butyl, sec-butyl, isobutyl, or tert-butyl, more preferably methyl, and
wherein m is an integer of 0 to 150, preferably an integer of 2 to 150, preferably an integer of 5 to 100, more preferably an integer of 7 to 50, more preferably an integer of 8 to 25, more preferably an integer of 9 to 20, more preferably an integer of 10 to 15,
it is preferred that R²⁹ is a substituted alkyl group, wherein the substituted alkyl group preferably comprises one or more substituents, wherein the one or more substituents of the substituted alkyl group are preferably selected from the group consisting of (C₁-C₃)alkoxy, hydroxyl, amino, halides, and combinations of two or more thereof, more preferably from the group consisting of (C₁-C₂)alkoxy, hydroxyl, amino, chloro, bromo, fluoro, and combinations of two or more thereof, more preferably from the group consisting of hydroxyl, amino, chloro, and combinations thereof, wherein more preferably the one or more substituents is hydroxyl,
wherein the substituted alkyl group preferably comprises one or more substituents, preferably 1 to 4 substituents, more preferably 1 to 3 substituents, more preferably 1 or 2 substituents, wherein the substituted alkyl group more preferably comprises 1 substituent.

Further in the case where R²³ is O—(R²⁸—O)ₘ—R²⁹,
wherein R²⁸ is an alkylene group,
wherein R²⁸ is preferably selected from the group consisting of methylene, ethylene, trimethylene, tetramethylene, pentamethylene, hexamethylene, ortho-phenylene, meta-phenylene, para-phenylene,
wherein R²⁸ more preferably is ethylene,
wherein R²⁹ more preferably is, optionally branched, preferably linear, (C₁-C₂₂)alkyl, preferably (C₁-C₁₈)alkyl, more preferably partially unsaturated (C₁-C₁₈)alkyl, more preferably (C₁-C₁₆)alkyl, more preferably (C₁-C₁₂)alkyl, more preferably (C₁-C₈)alkyl, more preferably (C₁-C₆)alkyl, more preferably (C₁-C₅)alkyl, more preferably (C₁-C₄)alkyl,
wherein R²⁹ more preferably is methyl, ethyl, propyl, isopropyl, n-butyl, sec-butyl, isobutyl, or tert-butyl, more preferably methyl, and
wherein m is an integer of 0 to 150, preferably an integer of 2 to 150, preferably an integer of 5 to 100, more preferably an integer of 7 to 50, more preferably an integer of 8 to 25, more preferably an integer of 9 to 20, more preferably an integer of 10 to 15,
it is preferred that R²⁹ is a partially unsaturated alkyl group, wherein R²⁹ preferably comprises one or more, more preferably from 1 to 5, more preferably from 1 to 3, more preferably one, C═C double bonds.

Further in the case where R²³ is O—(R²⁸—O)ₘ—R²⁹,
wherein R²⁸ is an alkylene group,
wherein R²⁸ is preferably selected from the group consisting of methylene, ethylene, trimethylene, tetramethylene, pentamethylene, hexamethylene, ortho-phenylene, meta-phenylene, para-phenylene,
wherein R²⁸ more preferably is ethylene,
wherein R²⁹ more preferably is, optionally branched, preferably linear, (C₁-C₂₂)alkyl, preferably (C₁-C₁₈)alkyl, more preferably partially unsaturated (C₁-C₁₈)alkyl, more preferably (C₁-C₁₆)alkyl, more preferably (C₁-C₁₂)alkyl, more preferably (C₁-C₈)alkyl, more preferably (C₁-C₆)alkyl, more preferably (C₁-C₅)alkyl, more preferably (C₁-C₄)alkyl,
wherein R²⁹ more preferably is methyl, ethyl, propyl, isopropyl, n-butyl, sec-butyl, isobutyl, or tert-butyl, more preferably methyl, and
wherein m is an integer of 0 to 150, preferably an integer of 2 to 150, preferably an integer of 5 to 100, more preferably an integer of 7 to 50, more preferably an integer of 8 to 25, more preferably an integer of 9 to 20, more preferably an integer of 10 to 15,
it is preferred that n=0, and
R²⁹ preferably is optionally partially unsaturated and/or optionally substituted (C₁-C₂₂)alkyl, preferably (C₁₂-C₂₂)alkyl, more preferably partially unsaturated (C₁₂-C₂₂)alkyl, more preferably partially unsaturated (C₁₆-C₂₀)alkyl, more preferably partially unsaturated (C₁₈-C₁₉)alkyl, wherein R²⁹ more preferably is partially unsaturated, wherein R²⁹ preferably comprises one or more, more preferably from 1 to 5, more preferably from 1 to 3, more preferably one, C═C double bonds, and wherein R²⁹ more preferably is (Z)-Octadec-9-en-yl (oleyl).

It is preferred that the one or more tertiary isocyanates comprised in the mixture according to (i) of the process comprises, preferably consists of, a tertiary monoisocyanate, preferably 3-isopropenyl-alpha,alpha-di methyl benzyl isocyanate (TMI).

It is preferred that the reaction conditions in (ii) of the process comprise heating the mixture obtained in (i) at a temperature in the range of from 50 to 220° C., preferably in the range of from 60 to 200° C., more preferably in the range of from 70 to 160° C., more preferably in the range of from 80 to 140° C.

It is preferred that the gas atmosphere in (ii) of the process comprises, preferably consists of, an inert gas, wherein the gas atmosphere in (ii) preferably comprises, more preferably consists of, one or more of nitrogen and argon.

It is preferred that the reaction conditions in (ii) of the process comprise applying a pressure to the reaction mixture obtained in (i) in the range of from 1 to 1000 hPa, preferably in the range of from 2 to 1000 hPa, more preferably in the range of from 2.5 to 1000 hPa, to the reaction mixture obtained in (i).

It is preferred that the reaction conditions in (ii) comprise agitating the mixture obtained in (i), preferably by stirring.

It is preferred that the mixture obtained in (i) of the process is subjected to reaction conditions in (ii) for a duration in the range of from 1 to 50 h, preferably in the range of from 1.5 to 40 h, more preferably in the range of from to 2 to 25 h.

It is preferred that the reactor according to (i) of the process comprises one or more of a reactor vessel and a tubular reactor.

It is preferred that the mixture provided in (i) of the process further comprises a first end-capping agent, wherein the first end-capping agent has the formula (III):

HO—(R¹¹—O)ₙ—R¹² (III),
wherein R¹¹ is an alkylene group,
wherein R¹¹ is preferably selected from the group consisting of methylene, ethylene, trimethylene, tetramethylene, pentamethylene, hexamethylene, ortho-phenylene, meta-phenylene, para-phenylene,
wherein R¹¹ more preferably is ethylene,
wherein R¹² more preferably is, optionally branched, preferably linear, (C₁-C₂₂)alkyl, preferably (C₁-C₁₈)alkyl, more preferably partially unsaturated (C₁-C₁₈)alkyl, more preferably (C₁-C₁₆)alkyl, more preferably (C₁-C₁₂)alkyl, more preferably (C₁-C₈)alkyl, more preferably (C₁-C₆)alkyl, more preferably (C₁-C₅)alkyl, more preferably (C₁-C₄)alkyl,
wherein R¹² more preferably is methyl, ethyl, propyl, isopropyl, n-butyl, sec-butyl, isobutyl, or tert-butyl, more preferably methyl, and
wherein n is an integer of 0 to 150, preferably an integer of 2 to 150, preferably an integer of 5 to 100, more preferably an integer of 7 to 50, more preferably an integer of 8 to 25, more preferably an integer of 9 to 20, more preferably an integer of 10 to 15,
wherein the first end-capping agent according to (iv) more preferably is a methylpolyethylene glycol.

In the case where the mixture provided in (i) of the process further comprises a first endcapping agent, wherein the first end-capping agent has the formula (III):

HO—(R¹¹—O)ₙ—R¹² (III),
wherein R¹¹ is an alkylene group,
wherein R¹¹ is preferably selected from the group consisting of methylene, ethylene, trimethylene, tetramethylene, pentamethylene, hexamethylene, ortho-phenylene, meta-phenylene, para-phenylene,
wherein R¹¹ more preferably is ethylene,
wherein R¹² more preferably is, optionally branched, preferably linear, (C₁-C₂₂)alkyl, preferably (C₁-C₁₈)alkyl, more preferably partially unsaturated (C₁-C₁₈)alkyl, more preferably (C₁-C₁₆)alkyl, more preferably (C₁-C₁₂)alkyl, more preferably (C₁-C₈)alkyl, more preferably (C₁-C₆)alkyl, more preferably (C₁-C₅)alkyl, more preferably (C₁-C₄)alkyl,
wherein R¹² more preferably is methyl, ethyl, propyl, isopropyl, n-butyl, sec-butyl, isobutyl, or tert-butyl, more preferably methyl, and
wherein n is an integer of 0 to 150, preferably an integer of 2 to 150, preferably an integer of 5 to 100, more preferably an integer of 7 to 50, more preferably an integer of 8 to 25, more preferably an integer of 9 to 20, more preferably an integer of 10 to 15,
wherein the first end-capping agent according to (iv) more preferably is a methylpolyethylene glycol,
it is preferred that R¹² is a substituted alkyl group, wherein the substituted alkyl group preferably comprises one or more substituents, wherein the one or more substituents of the substituted alkyl group are preferably selected from the group consisting of (C₁-C₃)alkoxy, hydroxyl, amino, halides, and combinations of two or more thereof, more preferably from the group consisting of (C₁-C₂)alkoxy, hydroxyl, amino, chloro, bromo, fluoro, and combinations of two or more thereof, more preferably from the group consisting of hydroxyl, amino, chloro, and combinations thereof, wherein more preferably the one or more substituents is hydroxyl,
wherein the substituted alkyl group preferably comprises one or more substituents, preferably 1 to 4 substituents, more preferably 1 to 3 substituents, more preferably 1 or 2 substituents, wherein the substituted alkyl group more preferably comprises 1 substituent.

Further in the case where the mixture provided in (i) of the process further comprises a first endcapping agent, wherein the first end-capping agent has the formula (III):

HO—(R¹¹—O)ₙ—R¹² (III),
wherein R¹¹ is an alkylene group,
wherein R¹¹ is preferably selected from the group consisting of methylene, ethylene, trimethylene, tetramethylene, pentamethylene, hexamethylene, ortho-phenylene, meta-phenylene, para-phenylene,
wherein R¹¹ more preferably is ethylene,
wherein R¹² more preferably is, optionally branched, preferably linear, (C₁-C₂₂)alkyl, preferably (C₁-C₁₈)alkyl, more preferably partially unsaturated (C₁-C₁₈)alkyl, more preferably (C₁-C₁₆)alkyl, more preferably (C₁-C₁₂)alkyl, more preferably (C₁-C₈)alkyl, more preferably (C₁-C₆)alkyl, more preferably (C₁-C₅)alkyl, more preferably (C₁-C₄)alkyl,
wherein R¹² more preferably is methyl, ethyl, propyl, isopropyl, n-butyl, sec-butyl, isobutyl, or tert-butyl, more preferably methyl, and
wherein n is an integer of 0 to 150, preferably an integer of 2 to 150, preferably an integer of 5 to 100, more preferably an integer of 7 to 50, more preferably an integer of 8 to 25, more preferably an integer of 9 to 20, more preferably an integer of 10 to 15,
wherein the first end-capping agent according to (iv) more preferably is a methylpolyethylene glycol,
it is preferred that R¹² is a partially unsaturated alkyl group, wherein R¹² preferably comprises one or more, more preferably from 1 to 5, more preferably from 1 to 3, more preferably one, C—C double bonds.

Further in the case where the mixture provided in (i) of the process further comprises a first endcapping agent, wherein the first end-capping agent has the formula (III):

HO—(R¹¹—O)ₙ—R¹² (III),
wherein R¹¹ is an alkylene group,
wherein R¹¹ is preferably selected from the group consisting of methylene, ethylene, trimethylene, tetramethylene, pentamethylene, hexamethylene, ortho-phenylene, meta-phenylene, para-phenylene,
wherein R¹¹ more preferably is ethylene,
wherein R¹² more preferably is, optionally branched, preferably linear, (C₁-C₂₂)alkyl, preferably (C₁-C₁₈)alkyl, more preferably partially unsaturated (C₁-C₁₈)alkyl, more preferably (C₁-C₁₆)alkyl, more preferably (C₁-C₁₂)alkyl, more preferably (C₁-C₈)alkyl, more preferably (C₁-C₆)alkyl, more preferably (C₁-C₅)alkyl, more preferably (C₁-C₄)alkyl,
wherein R¹² more preferably is methyl, ethyl, propyl, isopropyl, n-butyl, sec-butyl, isobutyl, or tert-butyl, more preferably methyl, and
wherein n is an integer of 0 to 150, preferably an integer of 2 to 150, preferably an integer of 5 to 100, more preferably an integer of 7 to 50, more preferably an integer of 8 to 25, more preferably an integer of 9 to 20, more preferably an integer of 10 to 15,
wherein the first end-capping agent according to (iv) more preferably is a methylpolyethylene glycol,
it is preferred that n=0, and
R¹² preferably is optionally partially unsaturated and/or optionally substituted (C₁-C₂₂)alkyl, preferably (C₁₂-C₂₂)alkyl, more preferably partially unsaturated (C₁₂-C₂₂)alkyl, more preferably partially unsaturated (C₁₆-C₂₀)alkyl, more preferably partially unsaturated (C₁₈-C₁₉)alkyl, wherein R¹² more preferably is partially unsaturated, wherein R¹² preferably comprises one or more, more preferably from 1 to 5, more preferably from 1 to 3, more preferably one, C—C double bonds, and wherein R¹² more preferably is (Z)-Octadec-9-en-yl (oleyl).

Further in the case where the mixture provided in (i) of the process further comprises a first endcapping agent, wherein the first end-capping agent has the formula (III):

HO—(R¹¹—O)ₙ—R¹² (III),
wherein R¹¹ is an alkylene group,
wherein R¹¹ is preferably selected from the group consisting of methylene, ethylene, trimethylene, tetramethylene, pentamethylene, hexamethylene, ortho-phenylene, meta-phenylene, para-phenylene,
wherein R¹¹ more preferably is ethylene,
wherein R¹² more preferably is, optionally branched, preferably linear, (C₁-C₂₂)alkyl, preferably (C₁-C₁₈)alkyl, more preferably partially unsaturated (C₁-C₁₈)alkyl, more preferably (C₁-C₁₆)alkyl, more preferably (C₁-C₁₂)alkyl, more preferably (C₁-C₈)alkyl, more preferably (C₁-C₆)alkyl, more preferably (C₁-C₅)alkyl, more preferably (C₁-C₄)alkyl,
wherein R¹² more preferably is methyl, ethyl, propyl, isopropyl, n-butyl, sec-butyl, isobutyl, or tert-butyl, more preferably methyl, and
wherein n is an integer of 0 to 150, preferably an integer of 2 to 150, preferably an integer of 5 to 100, more preferably an integer of 7 to 50, more preferably an integer of 8 to 25, more preferably an integer of 9 to 20, more preferably an integer of 10 to 15,
wherein the first end-capping agent according to (iv) more preferably is a methyl polyethylene glycol,
it is preferred that the first end-capping agent has an average molar mass in the range of from 100 to 5500 g/mol, preferably in the range of from 200 to 3300 g/mol, more preferably in the range of from 300 to 2200 g/mol, more preferably in the range of from 400 to 1100 g/mol, more preferably in the range of from 400 to 800 g/mol, more preferably in the range of from 450 to 550 g/mol.

Further in the case where the mixture provided in (i) of the process further comprises a first endcapping agent, wherein the first end-capping agent has the formula (III):

HO—(R¹¹—O)ₙ—R¹² (III),
wherein R¹¹ is an alkylene group,
wherein R¹¹ is preferably selected from the group consisting of methylene, ethylene, trimethylene, tetramethylene, pentamethylene, hexamethylene, ortho-phenylene, meta-phenylene, para-phenylene,
wherein R¹¹ more preferably is ethylene,
wherein R¹² more preferably is, optionally branched, preferably linear, (C₁-C₂₂)alkyl, preferably (C₁-C₁₈)alkyl, more preferably partially unsaturated (C₁-C₁₈)alkyl, more preferably (C₁-C₁₆)alkyl, more preferably (C₁-C₁₂)alkyl, more preferably (C₁-C₈)alkyl, more preferably (C₁-C₆)alkyl, more preferably (C₁-C₅)alkyl, more preferably (C₁-C₄)alkyl,
wherein R¹² more preferably is methyl, ethyl, propyl, isopropyl, n-butyl, sec-butyl, isobutyl, or tert-butyl, more preferably methyl, and
wherein n is an integer of 0 to 150, preferably an integer of 2 to 150, preferably an integer of 5 to 100, more preferably an integer of 7 to 50, more preferably an integer of 8 to 25, more preferably an integer of 9 to 20, more preferably an integer of 10 to 15,
wherein the first end-capping agent according to (iv) more preferably is a methylpolyethylene glycol,
it is preferred that the first end-capping agent according to (iv) exhibits a hydroxyl number in the range of from 5 to 200 mg (KOH)/g, preferably in the range of from 15 to 175 mg (KOH)/g, more preferably in the range of from 45 to 145 mg (KOH)/g, more preferably in the range of from 75 to 130 mg (KOH)/g, more preferably in the range of from 100 to 120 mg (KOH)/g, wherein the hydroxyl number is preferably determined according to DIN 53240.

Further in the case where the mixture provided in (i) of the process further comprises a first endcapping agent, wherein the first end-capping agent has the formula (III):

HO—(R¹¹—O)ₙ—R¹² (III),
wherein R¹¹ is an alkylene group,
wherein R¹¹ is preferably selected from the group consisting of methylene, ethylene, trimethylene, tetramethylene, pentamethylene, hexamethylene, ortho-phenylene, meta-phenylene, para-phenylene,
wherein R¹¹ more preferably is ethylene,
wherein R¹² more preferably is, optionally branched, preferably linear, (C₁-C₂₂)alkyl, preferably (C₁-C₁₈)alkyl, more preferably partially unsaturated (C₁-C₁₈)alkyl, more preferably (C₁-C₁₆)alkyl, more preferably (C₁-C₁₂)alkyl, more preferably (C₁-C₈)alkyl, more preferably (C₁-C₆)alkyl, more preferably (C₁-C₅)alkyl, more preferably (C₁-C₄)alkyl,
wherein R¹² more preferably is methyl, ethyl, propyl, isopropyl, n-butyl, sec-butyl, isobutyl, or tert-butyl, more preferably methyl, and
wherein n is an integer of 0 to 150, preferably an integer of 2 to 150, preferably an integer of 5 to 100, more preferably an integer of 7 to 50, more preferably an integer of 8 to 25, more preferably an integer of 9 to 20, more preferably an integer of 10 to 15,
wherein the first end-capping agent according to (iv) more preferably is a methylpolyethylene glycol,
it is preferred that the first end-capping agent exhibits viscosity in the range of from 5 to 200 mm²/s, preferably in the range of from 15 to 175 mm²/s, more preferably in the range of from 45 to 145 mm²/s, more preferably in the range of from 75 to 130 mm²/s, more preferably in the range of from 100 to 120 mm²/s, wherein the viscosity is preferably determined at a temperature in the range of from 15 to 25° C., more preferably at a temperature of 19 to 21° C., more preferably at a temperature of 20° C., wherein the viscosity is more preferably determined according to DIN 51562.

Further in the case where the mixture provided in (i) of the process further comprises a first endcapping agent, wherein the first end-capping agent has the formula (III):

HO—(R¹¹—O)ₙ—R¹² (III),
wherein R¹¹ is an alkylene group,
wherein R¹¹ is preferably selected from the group consisting of methylene, ethylene, trimethylene, tetramethylene, pentamethylene, hexamethylene, ortho-phenylene, meta-phenylene, para-phenylene,
wherein R¹¹ more preferably is ethylene,
wherein R¹² more preferably is, optionally branched, preferably linear, (C₁-C₂₂)alkyl, preferably (C₁-C₁₈)alkyl, more preferably partially unsaturated (C₁-C₁₈)alkyl, more preferably (C₁-C₁₆)alkyl, more preferably (C₁-C₁₂)alkyl, more preferably (C₁-C₈)alkyl, more preferably (C₁-C₆)alkyl, more preferably (C₁-C₅)alkyl, more preferably (C₁-C₄)alkyl,
wherein R¹² more preferably is methyl, ethyl, propyl, isopropyl, n-butyl, sec-butyl, isobutyl, or tert-butyl, more preferably methyl, and
wherein n is an integer of 0 to 150, preferably an integer of 2 to 150, preferably an integer of 5 to 100, more preferably an integer of 7 to 50, more preferably an integer of 8 to 25, more preferably an integer of 9 to 20, more preferably an integer of 10 to 15,
wherein the first end-capping agent according to (iv) more preferably is a methyl polyethylene glycol,
it is preferred that the first end-capping agent comprises equal to or less than 1 weight-%, preferably equal to or less than 0.6 weight-%, more preferably of equal to or less than 0.55 weight %, of water, based on 100 weight-% of the first end-capping agent, wherein the water content is preferably determined according to EN 13267.

Further in the case where the mixture provided in (i) of the process further comprises a first endcapping agent, wherein the first end-capping agent has the formula (III):

HO—(R¹¹—O)ₙ—R¹² (III),
wherein R¹¹ is an alkylene group,
wherein R¹¹ is preferably selected from the group consisting of methylene, ethylene, trimethylene, tetramethylene, pentamethylene, hexamethylene, ortho-phenylene, meta-phenylene, para-phenylene,
wherein R¹¹ more preferably is ethylene,
wherein R¹² more preferably is, optionally branched, preferably linear, (C₁-C₂₂)alkyl, preferably (C₁-C₁₈)alkyl, more preferably partially unsaturated (C₁-C₁₈)alkyl, more preferably (C₁-C₁₆)alkyl, more preferably (C₁-C₁₂)alkyl, more preferably (C₁-C₈)alkyl, more preferably (C₁-C₆)alkyl, more preferably (C₁-C₅)alkyl, more preferably (C₁-C₄)alkyl,
wherein R¹² more preferably is methyl, ethyl, propyl, isopropyl, n-butyl, sec-butyl, isobutyl, or tert-butyl, more preferably methyl, and
wherein n is an integer of 0 to 150, preferably an integer of 2 to 150, preferably an integer of 5 to 100, more preferably an integer of 7 to 50, more preferably an integer of 8 to 25, more preferably an integer of 9 to 20, more preferably an integer of 10 to 15,
wherein the first end-capping agent according to (iv) more preferably is a methylpolyethylene glycol,
it is preferred that the first end-capping agent is de-ionized.

It is preferred that a molar ratio of the one or more tertiary isocyanates comprised in the mixture according to (i) of the process, calculated as sum of the molar amounts of the one or more tertiary isocyanates, to the catalytic compound comprised in the mixture according to (i), calculated as molar amount of the cation comprised in the catalytic compound comprised in the mixture according to (i), in the mixture obtained in (i) is in the range of from 0.2:1 to 150:1, preferably in the range of from 0.4:1 to 125:1, more preferably in the range of from to 0.5:1 to 100:1, more preferably in the range of from to 1:1 to 85:1, more preferably in the range of from to 3:1 to 75:1, more preferably in the range of from to 6:1 to 70:1, more preferably in the range of from to 11:1 to 65:1, more preferably in the range of from 13:1 to 62:1.

It is preferred that the mixture obtained in (i) of the process comprises the catalytic compound in an amount in the range of from 0.1 to 50 mol-%, preferably in the range of from 0.5 to 20 mol-%, more preferably in the range of from 0.75 to 15 mol-%, more preferably in the range of from 0.80 to 12 mol-%, more preferably in the range of from 1.0 to 10 mol-%, more preferably in the range of from 1.5 to 7.5 mol-%, based on 100 mol-% of the one or more tertiary isocyanates, calculated as sum of the molar amounts of the one or more tertiary isocyanates.

It is preferred that the mixture obtained in (i) of the process comprises the catalytic compound in the range of from 0.5 to 10 weight-%, preferably in an amount in the range of from 1 to 7 weight-%, more preferably in the range of from 2 to 5.5 weight-%, more preferably in the range of from 2.5 to 5 weight-%, based on 100 weight-% of the one or more tertiary isocyanates, calculated as sum of the weights of the one or more tertiary isocyanates.

It is preferred that the mixture obtained in (i) of the process comprises equal to or less than 25 weight-%, preferably in the range of from 0.1 to 10 weight-%, more preferably in the range of from 1 to 5 weight-%, of xylene, preferably of an alkyl substituted benzene or an alkyl substituted dibenzene, wherein the alkyl comprises one or more of methyl, ethyl, and propyl, more preferably of a solvent, based on 100 weight-% of the mixture obtained in (i),
wherein the mixture obtained in (i) is more preferably essentially free of xylene, more preferably of an alkyl substituted benzene or an alkyl substituted dibenzene, wherein the alkyl comprises one or more of methyl, ethyl, and propyl, more preferably of a solvent.

It is preferred that the mixture obtained in (i) of the process comprises equal to or less than 5 weight-%, preferably in the range of from 0.1 to 1 weight-%, of a primary diisocyanate, preferably of a primary isocyanate, based on 100 weight-% of the mixture obtained in (ii), wherein the mixture prepared in (i) is more preferably essentially free of a primary diisocyanate, preferably of a primary isocyanate.

It is preferred that the mixture obtained in (i) of the process comprises equal to or less than 5 weight-%, preferably in the range of from 0.1 to 1 weight-%, of a secondary diisocyanate, preferably of a secondary isocyanate, based on 100 weight-% of the mixture obtained in (ii), where in the mixture prepared in (i) is more preferably essentially free of a secondary diisocyanate, preferably of a secondary isocyanate.

It is preferred that the mixture obtained in (ii) of the process comprises equal to or less than 35 mol-%, preferably in the range of from 1 to 20 mol-%, more preferably in the range of from 5 to 15 mol-%, of the one or more tertiary isocyanates, based on 100 mol-% of the one or more tertiary isocyanates, calculated as sum of the molar amounts of the one or more tertiary isocyanates, comprised in the mixture according to (i).

It is preferred that the process further comprises
(c) cooling the mixture obtained in (ii) to a temperature in the range of from 0 to less than 45° C., preferably in the range of from 10 to 25° C., for inhibiting further carbodiimidization, preferably for inhibiting further reaction.

It is preferred that the process further comprises
(iii) subjecting the mixture obtained in (ii) or (c) to distillation conditions, wherein the distillation conditions comprise heating the mixture obtained in (ii) or (c) at the boiling point of the one or more tertiary isocyanates comprised in the mixture obtained in (i) in a gas atmosphere; for separating at least a portion of the one or more tertiary isocyanates from the mixture, and preferably for degradation of at least a portion of the catalytic compound.

In the case where the process further comprises (iii) as defined herein, it is preferred that the distillation conditions comprise heating the mixture obtained in (ii) or (c) at a temperature in the range of from 170 to 210° C., preferably in the range of from 180 to 200° C.

Further in the case where the process further comprises (iii) as defined herein, it is preferred that the distillation conditions comprise applying a pressure to the reaction mixture obtained in (ii) or (c) in the range of from 1 to 250 hPa, preferably in the range of from 5 to 150 hPa, more preferably in the range of from 5 to 10 hPa.

Further in the case where the process further comprises (iii) as defined herein, it is preferred that the mixture obtained in (iii) comprises equal to or less than 10.5 weight-%, preferably equal to or less than 8.0 weight-%, of isocyanate groups NCO, based on 100 weight-% of the weight of the mixture obtained in (iii).

Further in the case where the process further comprises (iii) as defined herein, it is preferred that the process further comprises
(r) recycling a portion of the one or more tertiary isocyanates obtained in (iii) into (i).

It is preferred that the process further comprises
(d) subjecting the mixture obtained in (ii), (c) or (iii), preferably the mixture obtained in (iii), to degradation conditions in a gas atmosphere, for degradation of at least a portion of the catalytic compound,
   wherein the process preferably comprises (iv) and wherein the degradation conditions are the same as the distillation conditions in (iii).

In the case where the process further comprises (d) as defined herein, it is preferred that the degradation conditions comprise heating the mixture obtained in (ii), (c) or (iii) at a temperature in the range of from 100 to 220° C., preferably in the range of from 120 to 200° C., more preferably in the range of from 160 to 195° C.

Further in the case where the process further comprises (d) as defined herein, it is preferred that the degradation conditions comprise applying a pressure to the reaction mixture obtained in (ii), (c) or (iii) in the range of from 1 to 250 hPa, preferably in the range of from 5 to 150 hPa, more preferably in the range of from 5 to 10 hPa.

Further in the case where the process further comprises (d) as defined herein, it is preferred that the gas atmosphere in (d) comprises, preferably consists of, an inert gas, wherein the gas atmosphere in (d) preferably comprises, more preferably consists of, one or more of nitrogen and argon.

It is preferred that the process further comprises
(iv) mixing the carbodiimide and/or polycarbodiimide obtained in (ii), (c), (iii) or (d) with a second end-capping agent;
(v) subjecting the mixture obtained in (iv) in a gas atmosphere to end-capping conditions, for obtaining a carbodiimide and/or a polycarbodiimide comprising one or more end-caps; wherein the second end-capping agent according to (iv) preferably comprises one hydroxyl group.

In the case where the process further comprises (iv) and (v) as defined herein, it is preferred that the second end-capping agent according to (iv) has the formula (IV):

HO—(R²⁵—O)ₙ—R²⁶ (IV),
wherein R²⁵ is an alkylene group,
wherein R²⁵ is preferably selected from the group consisting of methylene, ethylene, trimethylene, tetramethylene, pentamethylene, hexamethylene, ortho-phenylene, meta-phenylene, para-phenylene,
wherein R²⁵ more preferably is ethylene,
wherein R²⁶ is an optionally partially unsaturated and/or optionally substituted alkyl group,
wherein R²⁶ more preferably is, optionally branched, preferably linear, (C₁-C₂₂)alkyl, preferably (C₁-C₁₈)alkyl, more preferably partially unsaturated (C₁-C₁₈)alkyl, more preferably (C₁-C₁₆)alkyl, more preferably (C₁-C₁₂)alkyl, more preferably (C₁-C₈)alkyl, more preferably (C₁-C₆)alkyl, more preferably (C₁-C₅)alkyl, more preferably (C₁-C₄)alkyl,
wherein R²⁶ more preferably is methyl, ethyl, propyl, isopropyl, n-butyl, sec-butyl, isobutyl, or tert-butyl, more preferably methyl, and
wherein n is an integer of 0 to 150, preferably an integer of 2 to 150, preferably an integer of 5 to 100, more preferably an integer of 7 to 50, more preferably an integer of 8 to 25, more preferably an integer of 9 to 20, more preferably an integer of 10 to 15,
wherein the second end-capping agent according to (iv) more preferably is a methylpolyethylene glycol.

In the case where the second end-capping agent according to (iv) has the formula (IV):

HO—(R²⁵—O)ₙ—R²⁶ (IV),
wherein R²⁵ is an alkylene group,
wherein R²⁵ is preferably selected from the group consisting of methylene, ethylene, trimethylene, tetramethylene, pentamethylene, hexamethylene, ortho-phenylene, meta-phenylene, para-phenylene,
wherein R²⁵ more preferably is ethylene,
wherein R²⁶ is an optionally partially unsaturated and/or optionally substituted alkyl group,
wherein R²⁶ more preferably is, optionally branched, preferably linear, (C₁-C₂₂)alkyl, preferably (C₁-C₁₈)alkyl, more preferably partially unsaturated (C₁-C₁₈)alkyl, more preferably (C₁-C₁₆)alkyl, more preferably (C₁-C₁₂)alkyl, more preferably (C₁-C₈)alkyl, more preferably (C₁-C₆)alkyl, more preferably (C₁-C₅)alkyl, more preferably (C₁-C₄)alkyl,
wherein R²⁶ more preferably is methyl, ethyl, propyl, isopropyl, n-butyl, sec-butyl, isobutyl, or tert-butyl, more preferably methyl, and
wherein n is an integer of 0 to 150, preferably an integer of 2 to 150, preferably an integer of 5 to 100, more preferably an integer of 7 to 50, more preferably an integer of 8 to 25, more preferably an integer of 9 to 20, more preferably an integer of 10 to 15,
wherein the second end-capping agent according to (iv) more preferably is a methylpolyethylene glycol,
it is preferred that R²⁶ is a substituted alkyl group, wherein the substituted alkyl group preferably comprises one or more substituents, wherein the one or more substituents of the substituted alkyl group are preferably selected from the group consisting of (C₁-C₃)alkoxy, hydroxyl, amino, halides, and combinations of two or more thereof, more preferably from the group consisting of (C₁-C₂)alkoxy, hydroxyl, amino, chloro, bromo, fluoro, and combinations of two or more thereof, more preferably from the group consisting of hydroxyl, amino, chloro, and combinations thereof,
wherein more preferably the one or more substituents is hydroxyl,
wherein the substituted alkyl group preferably comprises one or more substituents, preferably 1 to 4 substituents, more preferably 1 to 3 substituents, more preferably 1 or 2 substituents, wherein the substituted alkyl group more preferably comprises 1 substituent.

Further in the case where the second end-capping agent according to (iv) has the formula (IV):

HO—(R²⁵—O)ₙ—R²⁶ (IV),
wherein R²⁵ is an alkylene group,
wherein R²⁵ is preferably selected from the group consisting of methylene, ethylene, trimethylene, tetramethylene, pentamethylene, hexamethylene, ortho-phenylene, meta-phenylene, para-phenylene,
wherein R²⁵ more preferably is ethylene,
wherein R²⁶ is an optionally partially unsaturated and/or optionally substituted alkyl group,
wherein R²⁶ more preferably is, optionally branched, preferably linear, (C₁-C₂₂)alkyl, preferably (C₁-C₁₈)alkyl, more preferably partially unsaturated (C₁-C₁₈)alkyl, more preferably (C₁-C₁₆)alkyl, more preferably (C₁-C₁₂)alkyl, more preferably (C₁-C₈)alkyl, more preferably (C₁-C₆)alkyl, more preferably (C₁-C₅)alkyl, more preferably (C₁-C₄)alkyl,
wherein R²⁶ more preferably is methyl, ethyl, propyl, isopropyl, n-butyl, sec-butyl, isobutyl, or tert-butyl, more preferably methyl, and
wherein n is an integer of 0 to 150, preferably an integer of 2 to 150, preferably an integer of 5 to 100, more preferably an integer of 7 to 50, more preferably an integer of 8 to 25, more preferably an integer of 9 to 20, more preferably an integer of 10 to 15,
wherein the second end-capping agent according to (iv) more preferably is a methylpolyethylene glycol,
it is preferred that R²⁶ is a partially unsaturated alkyl group, wherein R²⁶ preferably comprises one or more, more preferably from 1 to 5, more preferably from 1 to 3, more preferably one, C═C double bonds.

Further in the case where the second end-capping agent according to (iv) has the formula (IV):

HO—(R²⁵—O)ₙ—R²⁶ (IV),
wherein R²⁵ is an alkylene group,
wherein R²⁵ is preferably selected from the group consisting of methylene, ethylene, trimethylene, tetramethylene, pentamethylene, hexamethylene, ortho-phenylene, meta-phenylene, para-phenylene,
wherein R²⁵ more preferably is ethylene,
wherein R²⁶ is an optionally partially unsaturated and/or optionally substituted alkyl group,
wherein R²⁶ more preferably is, optionally branched, preferably linear, (C₁-C₂₂)alkyl, preferably (C₁-C₁₈)alkyl, more preferably partially unsaturated (C₁-C₁₈)alkyl, more preferably (C₁-C₁₆)alkyl, more preferably (C₁-C₁₂)alkyl, more preferably (C₁-C₈)alkyl, more preferably (C₁-C₆)alkyl, more preferably (C₁-C₅)alkyl, more preferably (C₁-C₄)alkyl,
wherein R²⁶ more preferably is methyl, ethyl, propyl, isopropyl, n-butyl, sec-butyl, isobutyl, or tert-butyl, more preferably methyl, and
wherein n is an integer of 0 to 150, preferably an integer of 2 to 150, preferably an integer of 5 to 100, more preferably an integer of 7 to 50, more preferably an integer of 8 to 25, more preferably an integer of 9 to 20, more preferably an integer of 10 to 15,
wherein the second end-capping agent according to (iv) more preferably is a methylpolyethylene glycol,
it is preferred that n=0, and
R²⁶ preferably is optionally partially unsaturated and/or optionally substituted (C₁-C₂₂)alkyl, preferably (C₁₂-C₂₂)alkyl, more preferably partially unsaturated (C₁₂-C₂₂)alkyl, more preferably partially unsaturated (C₁₆-C₂₀)alkyl, more preferably partially unsaturated (C₁₈-C₁₉)alkyl, wherein R²⁶ more preferably is partially unsaturated, wherein R²⁶ preferably comprises one or more, more preferably from 1 to 5, more preferably from 1 to 3, more preferably one, C═C double bonds, and wherein R²⁶ more preferably is (Z)-Octadec-9-en-yl (oleyl).

In the case where the process further comprises (iv) and (v) as defined herein, it is preferred that the second end-capping agent according to (iv) has an average molar mass in the range of from 100 to 5500 g/mol, preferably in the range of from 200 to 3300 g/mol, more preferably in the range of from 300 to 2200 g/mol, more preferably in the range of from 400 to 1100 g/mol, more preferably in the range of from 400 to 800 g/mol, more preferably in the range of from 450 to 550 g/mol.

Further in the case where the process further comprises (iv) and (v) as defined herein, it is preferred that the second end-capping agent according to (iv) exhibits a hydroxyl number in the range of from 5 to 200 mg (KOH)/g, preferably in the range of from 15 to 175 mg (KOH)/g, more preferably in the range of from 45 to 145 mg (KOH)/g, more preferably in the range of from 75 to 130 mg (KOH)/g, more preferably in the range of from 100 to 120 mg (KOH)/g, wherein the hydroxyl number is preferably determined according to DIN 53240.

Further in the case where the process further comprises (iv) and (v) as defined herein, it is preferred that the second end-capping agent according to (iv) exhibits viscosity in the range of from 5 to 200 mm²/s, preferably in the range of from 15 to 175 mm²/s, more preferably in the range of from 45 to 145 mm²/s, more preferably in the range of from 75 to 130 mm²/s, more preferably in the range of from 100 to 120 mm²/s, wherein the viscosity is preferably determined at a temperature in the range of from 15 to 25° C., more preferably at a temperature of 19 to 21° C., more preferably at a temperature of 20° C., wherein the viscosity is more preferably determined ac cording to DIN 51562.

Further in the case where the process further comprises (iv) and (v) as defined herein, it is preferred that the second end-capping agent according to (iv) comprises equal to or less than 1 weight-%, preferably equal to or less than 0.6 weight-%, more preferably of equal to or less than 0.55 weight-%, of water, based on 100 weight-% of the second end-capping agent, wherein the water content is preferably determined according to EN 13267.

Further in the case where the process further comprises (iv) and (v) as defined herein, it is preferred that the second end-capping agent according to (iv) is de-ionized.

Further in the case where the process further comprises (iv) and (v) as defined herein, it is preferred that the mixture obtained in (v) comprises from 55 to 85 weight-%, preferably from 60 to 80 weight-%, more preferably from 65 to 75 weight-%, of the second end-capping agent, based on 100 weight-% of the polycarbodiimide obtained in (ii), (iii) or (d).

Further in the case where the process further comprises (iv) and (v) as defined herein, it is preferred that the gas atmosphere in (v) comprises, preferably consists of, an inert gas, wherein the gas atmosphere in (v) preferably comprises, more preferably consists of, one or more of nitrogen and argon.

Further in the case where the process further comprises (iv) and (v) as defined herein, it is preferred that the end-capping conditions according to (v) comprise heating the mixture obtained in (iv) to a temperature in the range of from 80 to 160° C., preferably in the range of from 100 to 140° C., more preferably in the range of from 110 to 130° C.

Further in the case where the process further comprises (iv) and (v) as defined herein, it is preferred that the mixture obtained in (iv) is subjected to end-capping conditions according to (v) for a duration in the range of from 1 to 10 h, preferably in the range of from 3 to 7 h, more preferably in the range of from 4 to 6 h.

Further in the case where the process further comprises (iv) and (v) as defined herein, it is preferred that the carbodiimide and/or polycarbodiimide being end-capped obtained in (v) comprises equal to or less than 0.1 weight-%, preferably equal to or less than 0.01 weight-%, more preferably equal to or less than 0.001 weight-%, of isocyanate groups NCO, based on 100 weight-% of the mixture obtained in (v).

It is preferred that the process further comprises
(vi) isolating the carbodiimide and/or polycarbodiimide, from the mixture obtained in (ii), (c), (iii), (v) or (d).

Further, the present invention relates to a carbodiimide and/or a polycarbodiimide as obtained and/or obtainable by the process according to any one of the embodiments disclosed herein. It is preferred that the carbodiimide and/or polycarbodiimide comprises at least 1, preferably from 1 to 30, more preferably from 2 to 15, carbodiimide groups.

Yet further, the present invention relates to a use of a carbodiimide and/or polycarbodiimide according to any one of the embodiments disclosed herein as a stabilizer, preferably as a hydrolysis stabilizer, for a polymer, more preferably for a thermoplastic polymer, more preferably for a thermoplastic polyester, more preferably for one or more of a polyurethane (PU), preferably a thermoplastic polyurethane (TPU), a polyurea, a polyethylene terephthalate (PET), a polybutylene terephthalate (PBT), a polyactide (PLA), a polyamide, a polyesteramide, a polycaprolactone, and a polyethersulfone (PES).

The present invention is further illustrated by the following set of embodiments and combinations of embodiments resulting from the dependencies and back-references as indicated. In particular, it is noted that in each instance where a range of embodiments is mentioned, for example in the context of a term such as “A preferred embodiment (5) concretizing any one of embodiments (1) to (4)”, every embodiment in this range is meant to be explicitly disclosed for the skilled person, i.e. the wording of this term is to be understood by the skilled person as being synonymous to “A preferred embodiment (5) concretizing any one of embodiments 1, 2, 3, and 4”. Further, it is explicitly noted that the following set of embodiments is not the set of claims determining the extent of protection, but represents a suitably structured part of the description directed to general and preferred aspects of the present invention.

According to an embodiment (1), the present invention relates to a process for the preparation of a carbodiimide and/or a polycarbodiimide, preferably for the preparation of a polycarbodiimide, the process comprising
(i) providing a mixture comprising one or more tertiary isocyanates and a catalytic compound;
   wherein the catalytic compound comprises a cation [R¹R²R³R⁴X]⁺,
   wherein in the cation X═N or P,
   wherein R¹, R², R³, and R⁴ in the cation independently from one another is an optionally branched and/or optionally cyclic and/or optionally substituted alkyl, alkaryl, aralkyl, or aryl, wherein R¹ and R² optionally form an optionally heteroatom-containing ring, wherein the heteroatom is preferably NR²⁷, 0 or S, wherein R²⁷ is H or alkyl, wherein R¹, R² and R³ optionally form two rings;
   wherein the mixture obtained in (i) comprises equal to or less than 1.75 mol-% of an alkali metal, calculated as elemental alkali metal, based on 100 mol-% of the one or more tertiary isocyanates, calculated as sum of the molar amounts of the one or more tertiary isocyanates;
(ii) subjecting the mixture obtained in (i) to reaction conditions in a gas atmosphere, wherein the reaction conditions comprise heating the reaction mixture at a temperature in the range of from 45 to 220° C.;
   to obtain a mixture comprising the carbodiimide and/or polycarbodiimide, preferably a mixture comprising the polycarbodiimide.

A preferred embodiment (2) concretizing embodiment (1) relates to said process, wherein the mixture obtained in (i) comprises equal to or less than 1.50 mol-%, preferably equal to or less than 1.00 mol-%, more preferably equal to or less than 0.60 mol-%, preferably equal to or less than 0.50 mol-%, more preferably equal to or less than 0.40 mol-%, more preferably equal to or less than 0.30 mol-%, more preferably equal to or less than 0.20 mol-%, more preferably equal to or less than 0.10 mol-%, more preferably equal to or less than 0.09 mol-%, more preferably equal to or less than 0.08 mol-%, more preferably equal to or less than 0.07 mol-%, more preferably equal to or less than 0.06 mol-%, more preferably equal to or less than 0.05 mol-%, more preferably equal to or less than 0.04 mol-%, more preferably equal to or less than 0.03 mol-%, more preferably equal to or less than 0.02 mol-%, more preferably equal to or less than 0.01 mol-%, more preferably equal to or less than 0.001 mol-%, of an alkali metal, calculated as elemental alkali metal, based on 100 mol-% of the one or more tertiary isocyanates, calculated as sum of the molar amounts of the one or more tertiary isocyanates, wherein the mixture obtained in (i) is more preferably essentially free of an alkali metal.

A preferred embodiment (3) concretizing embodiment (1) or (2) relates to said process, wherein the mixture obtained in (i) comprises equal to or less than 1.75 mol-%, preferably equal to or less than 1.50 mol-%, more preferably equal to or less than 1.00 mol-%, more preferably equal to or less than 0.60 mol-%, preferably equal to or less than 0.50 mol-%, more preferably equal to or less than 0.40 mol-%, more preferably equal to or less than 0.30 mol-%, more preferably equal to or less than 0.20 mol-%, more preferably equal to or less than 0.10 mol-%, more preferably equal to or less than 0.09 mol-%, more preferably equal to or less than 0.08 mol-%, more preferably equal to or less than 0.07 mol-%, more preferably equal to or less than 0.06 mol-%, more preferably equal to or less than 0.05 mol-%, more preferably equal to or less than 0.04 mol-%, more preferably equal to or less than 0.03 mol-%, more preferably equal to or less than 0.02 mol-%, more preferably equal to or less than 0.01 mol-%, more preferably equal to or less than 0.001 mol-%, of Mg, calculated as elemental Mg, preferably of Mg and/or Ca, calculated as elemental Mg and elemental Ca, respectively, more preferably of one or more of Mg, Ca, and Ba, calculated as elemental Mg, as elemental Ca and elemental Ba, respectively, more preferably of one or more of an alkali earth metal, calculated as elemental alkali earth metal, based on 100 mol-% of the one or more tertiary isocyanates, calculated as sum of the molar amounts of the one or more tertiary isocyanates, wherein the mixture obtained in (i) more preferably is essentially free of Mg, more preferably of Mg and/or Ca, more preferably of one or more of Mg, Ca, and Ba, more preferably of one or more of an alkali earth metal.

A preferred embodiment (4) concretizing any one of embodiments (1) to (3) relates to said process, wherein X═N in the cation comprised in the catalytic compound comprised in the mixture according to (i), and wherein the mixture obtained in (i) comprises equal to or less than 5 mol-%, preferably equal to or less than 2.5 mol-%, more preferably equal to or less than 2.0 mol-%, more preferably equal to or less than 1.5 mol-%, more preferably equal to or less than 1.0 mol-%, more preferably equal to or less than 0.7 mol-%, more preferably equal to or less than 0.5 mol-%, more preferably equal to or less than 0.2 mol-%, more preferably equal to or less than 0.1 mol-%, more preferably equal to or less than 0.05 mol-%, more preferably equal to or less than 0.02 mol-%, more preferably equal to or less than 0.01 mol-%, of a compound comprising a phosphorous oxygen double bond, calculated as molar amount of the compound comprising a phosphorous oxygen double bond, preferably of a phospholene oxide, calculated as molar amount of the phospholene oxide, more preferably of a compound comprising P, calculated as molar amount of the compound comprising P, more preferably of P, calculated as elemental P, based on 100 mol-% of the one or more tertiary isocyanates, calculated as sum of the molar amounts of the one or more tertiary isocyanates, wherein the mixture obtained in (i) more preferably is essentially free of a compound comprising a phosphorous oxygen double bond, preferably of a phospholene oxide, more preferably of a compound comprising P, and more preferably of P.

A preferred embodiment (5) concretizing any one of embodiments (1) to (4) relates to said process, wherein the catalytic compound comprises one or more of a hydroxide anion and a carboxylate anion [R⁵—COO]⁻, wherein the catalytic compound preferably comprises a carboxylate anion [R⁵—COO]⁻, wherein R⁵ in the carboxylate anion is hydroxyl (OH) or an optionally branched and/or optionally substituted (C₁-C₁₂)alkyl, wherein R⁵ in the carboxylate anion preferably is hydroxyl (OH) or an optionally branched (C₁-C₁₂)alkyl.

A preferred embodiment (6) concretizing any one of embodiments (1) to (5) relates to said process, wherein the catalytic compound comprises a hydroxide anion.

A preferred embodiment (7) concretizing embodiment (6) relates to said process, wherein from 95 to 100 weight-%, preferably from 99 to 100 weight-%, more preferably from 99.9 to 100 weight-%, of the catalytic compound comprised in the mixture according to (i) consists of the cation [R¹R²R³R⁴X]⁺ and the hydroxide anion, wherein the catalytic compound more preferably essentially consists of the cation [R¹R²R³R⁴X]⁺ and the hydroxide anion.

A preferred embodiment (8) concretizing embodiment (5) relates to said process, wherein the catalytic compound comprises a carboxylate anion [R⁵—COO]⁻, wherein R⁵ in the carboxylate anion is hydroxyl (OH) or an optionally branched and/or optionally substituted (C₁-C₁₂)alkyl, wherein R⁵ in the carboxylate anion preferably is hydroxyl (OH) or an optionally branched (C₁-C₁₂)alkyl.

A preferred embodiment (9) concretizing embodiment (8) relates to said process, wherein from 95 to 100 weight-%, preferably from 99 to 100 weight-%, more preferably from 99.9 to 100 weight-%, of the catalytic compound comprised in the mixture according to (i) consists of the cation [R¹R²R³R⁴X]⁺ and the carboxylate anion [R⁵—COO]⁻, wherein the catalytic compound more preferably essentially consists of the cation [R¹R²R³R⁴X]⁺ and the carboxylate anion [R⁵—COO]⁻.

A preferred embodiment (10) concretizing embodiment (8) or (9) relates to said process, wherein R⁵ of the carboxylate anion [R⁵—COO]⁻ preferably is alkyl or phenyl,
wherein R⁵ of the carboxylate anion [R⁵—COO]⁻ more preferably is, optionally branched, more preferably linear, (C₁-C₂₂)alkyl, preferably (C₁-C₁₆)alkyl, more preferably (C₁-C₁₂)alkyl, more preferably (C₁-C₈)alkyl, more preferably (C₁-C₆)alkyl, more preferably (C₁-C₅)alkyl, more preferably (C₁-C₄)alkyl, more preferably (C₁-C₂)alkyl,
wherein R⁵ of the carboxylate anion [R⁵—COO]⁻ more preferably is selected from the group consisting of methyl, ethyl, propyl, iso-propyl, tert-butyl, iso-butyl, sec-butyl, n-butyl, n-pentyl, 2-methylbutan-2-yl (tert-pentyl), 2,2-dimethylpropyl (neo-pentyl), 3-methylbutyl (iso-pentyl), pentan-2-yl (sec-pentyl), pentan-3-yl, 3-methylbutan-2-yl, 2-methylbutyl, hexyl, 1,1-dimethyl-butyl, heptyl, 2-methyl-2-ethyl-butyl, 2,2-dimethyl-pentyl, 1-ethyl-pentyl, octyl, 1-ethylhexyl, nonyl, decyl, lauryl, myristyl, cetyl, stearyl, phenyl, para-tert-butyl-phenyl, para-methyl-phenyl, and ortho-methyl-phenyl,
wherein R⁵ of the carboxylate anion [R⁵—COO]⁻ more preferably is selected from the group consisting of methyl, ethyl, and 1-ethyl-pentyl.

A preferred embodiment (11) concretizing any one of embodiments (8) to (10) relates to said process, wherein the (C₁-C₁₂)alkyl is substituted, wherein the substituted (C₁-C₁₂)alkyl comprises one or more substituents, wherein the one or more substituents of the substituted (C₁-C₁₂)alkyl are preferably selected from the group consisting of (C₁-C₃)alkoxy, hydroxyl, amino, halides, and combinations of two or more thereof, more preferably from the group consisting of (C₁-C₂)alkoxy, hydroxyl, amino, chloro, bromo, fluoro, and combinations of two or more thereof, more preferably from the group consisting of hydroxyl, amino, chloro, and combinations thereof, wherein more preferably the one or more substituents is hydroxyl.

A preferred embodiment (12) concretizing any one of embodiments (8) to (11) relates to said process, wherein the (C₁-C₁₂)alkyl is substituted, wherein the substituted (C₁-C₁₂)alkyl comprises one or more optional substituents, wherein the substituted (C₁-C₁₂)alkyl preferably comprises 1 to 4 substituents, more preferably 1 to 3 substituents, more preferably 1 or 2 substituents, wherein the substituted (C₁-C₁₂)alkyl more preferably comprises 1 substituent.

A preferred embodiment (13) concretizing any one of embodiments (8) to (12) relates to said process, wherein the carboxylate anion [R⁵—COO]⁻ comprised in the catalytic compound comprised in the mixture according to (i) is selected from the group consisting of acetate, propionate, 2-ethylhexanoate, adipate, benzoate, oxalate, and a mixture of two or more thereof, wherein the carboxylate anion [R⁵—COO]⁻ preferably is acetate or 2-ethylhexanoate.

A preferred embodiment (14) concretizing any one of embodiments (1) to (13) relates to said process, wherein X═P in the cation comprised in the catalytic compound comprised in the mixture according to (i).

A preferred embodiment (15) concretizing any one of embodiments (1) to (14) relates to said process, wherein X═N in the cation comprised in the catalytic compound comprised in the mixture according to (i).

A preferred embodiment (16) concretizing any one of embodiments (1) to (15) relates to said process, wherein R¹, R², R³, and R⁴ in the cation comprised in the catalytic compound comprised in the mixture according to (i) independently from one another is selected from the group consisting of optionally branched and/or optionally cyclic, preferably linear, and/or optionally substituted (C₁-C₂₂)alkyl, cycloaliphatic (C₅-C₂₀)alkyl, (C₆-C₁₈)aryl, (C₇-C₂₀)aralkyl, and (C₇-C₂₀)alkaryl,
preferably selected from the group consisting of optionally branched and/or optionally cyclic, preferably linear, and/or optionally substituted (C₁-C₁₆)alkyl, cycloaliphatic (C₅-C₁₀)alkyl, (C₆-C₁₈)aryl, (C₇-C₂₀)aralkyl, and (C₇-C₂₀)alkaryl,
more preferably selected from the group consisting of optionally branched and/or optionally cyclic, preferably linear, and/or optionally substituted (C₁-C₁₂)alkyl, cycloaliphatic (C₅-C₁₀)alkyl, (C₆-C₉)aryl, (C₇-C₁₅)aralkyl, and (C₇-C₁₅)alkaryl, more preferably selected from the group consisting of optionally branched and/or optionally cyclic, preferably linear, and/or optionally substituted (C₁-C₈)alkyl, cycloaliphatic (C₅-C₆)alkyl, (C₆-C₉)aryl, (C₇-C₁₂)aralkyl, and (C₇-C₁₂)alkaryl,
more preferably selected from the group consisting of optionally branched and/or optionally cyclic, preferably linear, and/or optionally substituted (C₁-C₆)alkyl, cycloaliphatic (C₅-C₆)alkyl, and (C₆)aryl,
more preferably selected from the group consisting of optionally branched and/or optionally cyclic, preferably linear, and/or optionally substituted (C₁-C₅)alkyl,
more preferably selected from the group consisting of optionally branched and/or optionally cyclic, preferably linear, and/or optionally substituted (C₁-C₄)alkyl,
wherein preferably R¹, R², R³, and R⁴ in the cation independently from one another is, optionally substituted, methyl, ethyl, propyl, isopropyl, n-butyl, sec-butyl, isobutyl, or tert-butyl,
wherein more preferably R¹ in the cation is, optionally substituted, methyl or n-butyl, and R², R³, and R⁴ in the cation independently from one another is, optionally substituted, methyl, ethyl, propyl, isopropyl, n-butyl, sec-butyl, isobutyl, or tert-butyl,
wherein more preferably R¹ in the cation is, optionally substituted, methyl and R², R³, and R⁴ in the cation independently from one another is, optionally substituted, methyl or n-butyl, wherein more preferably R¹, R², R³, and R⁴ in the cation independently from one another is, optionally substituted, methyl or n-butyl,
wherein R¹ and R² preferably form an optionally heteroatom-containing ring, wherein the heteroatom is preferably NR²⁷, O or S, more preferably O, wherein R²⁷ is preferably H, methyl, ethyl, propyl, isopropyl, n-butyl, tert-butyl, or isobutyl, more preferably methyl, wherein R¹, R² and R³ preferably form two rings.

A preferred embodiment (17) concretizing any one of embodiments (1) to (16) relates to said process, wherein R¹, R², and R³ in the cation comprised in the catalytic compound comprised in the mixture according to (i) independently from one another is optionally substituted alkyl, wherein R¹, R², and R³ in the cation independently from one another preferably is, optionally branched, preferably linear, and/or optionally substituted (C₁-C₂₂)alkyl, preferably (C₁-C₁₆)alkyl, more preferably (C₁-C₁₂)alkyl, more preferably (C₁-C₈)alkyl, more preferably (C₁-C₆)alkyl, more preferably (C₁-C₅)alkyl, more preferably (C₁-C₄)alkyl,
wherein R¹, R², and R³ in the cation independently from one another more preferably is, option ally substituted, methyl, ethyl, propyl, isopropyl, n-butyl, sec-butyl, isobutyl, or tert-butyl,
wherein R¹, R², and R³ in the cation independently from one another more preferably is, optionally substituted, methyl or n-butyl,
and wherein R⁴ in the cation is, optionally substituted, benzyl or phenyl.

A preferred embodiment (18) concretizing any one of embodiments (1) to (17) relates to said process, wherein one or more of R¹, R², R³, and R⁴ in the cation comprised in the catalytic compound comprised in the mixture according to (i) are substituted, wherein the one or more optional substituents of the one or more substituted R¹, R², R³, and R⁴ are preferably selected from the group consisting of (C₁-C₃)alkoxy, hydroxyl, amino, halides, and combinations of two or more thereof, more preferably from the group consisting of (C₁-C₂)alkoxy, hydroxyl, amino, chloro, bromo, fluoro, and combinations of two or more thereof, more preferably from the group consisting of hydroxyl, amino, chloro, and combinations thereof, wherein more preferably the one or more optional substituents is hydroxyl.

A preferred embodiment (19) concretizing any one of embodiments (1) to (18) relates to said process, wherein one or more of R¹, R², R³, and R⁴ in the cation comprised in the catalytic compound comprised in the mixture according to (i) are substituted, wherein the one or more substituted R¹, R², R³, and R⁴ independently from each other comprise one or more substituents, wherein the one or more substituted R¹, R², R³, and R⁴ independently from each other preferably comprises 1 to 4 substituents, more preferably 1 to 3 substituents, more preferably 1 or 2 substituents, wherein the one or more substituted R¹, R², R³, and R⁴ independently from each other more preferably comprise 1 substituent.

A preferred embodiment (20) concretizing any one of embodiments (1) to (19) relates to said process, wherein X═N in the cation comprised in the catalytic compound comprised in the mixture according to (i), wherein the cation comprised in the catalytic compound comprised in the mixture according to (i) is selected from the group consisting of tetramethylammonium, tetraethylammonium, tetrapropylammonium, tri-n-butylmethylammonium, tri-n-butylethylammonium, tetra-n-butylammonium, benzyltrimethylammonium, benzyltriethylammonium, benzyltri-n-butylammonium, benzyldimethyloctylammonium, benzyldimethyldecylammonium, benzyldimethyldodecylammonium, methyltriethylammonium, phenyltrimethylammonium, behentrimonium, cetyltrimethylammonium, cetalkonium, cetyldimethylbenzylammonium, cetyldimethylethylammonium, cetrimide, didecyldimethylammonium, decyltrimethylammonium, dodecyltrimethylammonium, myristyltrimethylammonium, methyltrioctylammonium, stearyltrimethylammonium, stearyltributylammonium, tetraoctylammonium, trimethyloctylammonium, trioctylmethylammonium, diisopropyldiethylammonium, diisopropylethylmethylammonium, diisopropylethylbenzylammonium, N,N-dimethylpiperidinium, N,N-dimethylmorpholinium, N,N-dimethylpiperazinium or N-methyldiazabicyclo[2.2.2]octane, 2-hydroxyethyl trimethylammonium, 2-hydroxypropyl trimethylammonium, 2-hydroxyethyl triethylammonium, 2-hydroxypropyl triethylammonium, 2-hydroxyethyl tri-n-butylammonium, 2-hydroxypropyl tri-n-butylammonium, 2-hydroxyethyl dimethyl benzyl ammonium, 2-hydroxypropyl dimethyl benzyl ammonium, 2-hydroxyethyl trimethylammonium, 2-hydroxypropyl trimethylammonium, 2-hydroxyethyl dimethyl benzyl ammonium, N-(2-hydroxyethyl)-N-methyl morpholinium, N-(2-hydroxypropyl)-N-methyl morpholinium, N,N-dimethylmorpholinium, N,N-dimethylpiperidinium, N,N-dimethylpiperazinium, N-methyldiazabicyclo[2.2.2]octane, 3-hydroxy quinuclidine, 3-hydroxy quinuclidine, and a mixture of two or more thereof,
wherein the cation preferably is selected from the group consisting of tetramethylammonium, tri-n-butylmethylammonium, tetra-n-butylammonium, and a mixture of two or more thereof, wherein the cation more preferably is tetramethylammonium, tetra-n-butylammonium or tri-n-butylmethylammonium.

A preferred embodiment (21) concretizing any one of embodiments (1) to (20) relates to said process, wherein the one or more tertiary isocyanates comprised in the mixture according to (i) comprises, preferably consists of, one or more tertiary monoisocyanates, preferably of a tertiary monoisocyanate, one or more tertiary diisocyanates, preferably a tertiary diisocyanate, or a mixture thereof.

A preferred embodiment (22) concretizing embodiment (21) relates to said process, wherein the isocyanate group of each of the one or more tertiary monoisocyanates is bound to a tertiary carbon atom.

A preferred embodiment (23) concretizing embodiment (21) or (22) relates to said process, wherein each of the two isocyanate groups of the one or more tertiary diisocyanates is bound to a tertiary carbon atom.

A preferred embodiment (24) concretizing any one of embodiments (21) to (23) relates to said process, wherein the one or more tertiary diisocyanates comprises, preferably consists of, a tertiary diisocyanate having the formula (II):

OCN—C(R⁶,R⁷)—R⁸—C(R⁹,R¹⁰)—NCO (II),
wherein R⁶, R⁷, R⁹ and R¹⁰ independently from one another is alkyl,
wherein R⁶, R⁷, R⁹ and R¹⁰ independently from one another preferably is, optionally branched, preferably linear, (C₁-C₂₂)alkyl, preferably (C₁-C₁₆)alkyl, more preferably (C₁-C₁₂)alkyl, more preferably (C₁-C₈)alkyl, more preferably (C₁-C₆)alkyl, more preferably (C₁-C₅)alkyl, more preferably (C₁-C₄)alkyl,
wherein R⁶, R⁷, R⁹ and R¹⁰ independently from one another more preferably is methyl, ethyl, propyl, isopropyl, n-butyl, sec-butyl, isobutyl, or tert-butyl, more preferably methyl, wherein R⁸ is an optionally branched and/or cyclic alkylene, alkarylene, aralkylene, or arylene, wherein R⁸ is preferably selected from the group consisting of linear or branched (C₁-C₁₅)alkylene, cycloaliphatic (C₅-C₂₀)alkylene, (C₆-C₁₈)arylene, (C₇-C₂₀)aralkylene, and (C₇-C₂₀)alkarylene, preferably selected from the group consisting of (C₁-C₈)alkylene, cycloaliphatic (C₅-C₁₀)alkylene, (C₆-C₉)arylene, (C₇-C₁₅)aralkylene, and (C₇-C₁₅)alkarylene, more preferably selected from the group consisting of (C₁-C₆)alkylene, (C₅-C₆)alkylene, (C₆)arylene, (C₇-C₁₂)aralkylene, and (C₇-C₁₂)alkarylene, more preferably selected from the group consisting of (C₃-C₆)alkylene, (C₇-C₁₀)aralkylene, and (C₇-C₁₀)alkarylene, more preferably selected from the group consisting of (C₇-C₉)aralkylene, and (C₇-C₉)alkarylene, wherein R⁸ is more preferably selected from the group consisting of (C₈-C₉)aralkylene, and (C₈-C₉)alkarylene,
wherein R⁸ is more preferably selected from the group consisting of methylene, ethylene, trimethylene, tetramethylene, pentamethylene, hexamethylene, ortho-phenylene, meta-phenylene, and para-phenylene,
wherein R⁸ more preferably is selected from the group consisting of pentamethylene, hexamethylene, ortho-phenylene, meta-phenylene, and para-phenylene,
wherein R⁸ more preferably is para-phenylene.

A preferred embodiment (25) concretizing any one of embodiments (1) to (24) relates to said process, wherein the one or more tertiary isocyanates comprised in the mixture according to (i) comprises, preferably consists of, a tertiary diisocyanate, preferably 1,3-bis(1-methyl-1-isocyanatoethyl)-benzene.

A preferred embodiment (26) concretizing any one of embodiments (1) to (25) relates to said process, wherein the one or more tertiary isocyanates comprised in the mixture according to (i) comprises from 10 to 44 weight-%, preferably from 15 to 40 weight-%, more preferably from 32 to 37 weight-%, of NCO, based on 100 weight-% of the one or more tertiary isocyanates, calculated as sum of the weights of the one or more tertiary isocyanates.

A preferred embodiment (27) concretizing any one of embodiments (21) to (26) relates to said process, wherein the one or more tertiary monoisocyanates comprises, preferably consists of, a monoisocyanate having the formula (II):

OCN—C(R¹³,R¹⁴)—R¹⁵—C(R¹⁶,R¹⁷)—R¹⁸ (II),
wherein R¹³ and R¹⁴ independently from one another is alkyl,
wherein R¹³ and R¹⁴ independently from one another preferably is optionally branched, preferably linear, (C₁-C₂₂)alkyl, preferably (C₁-C₁₆)alkyl, more preferably (C₁-C₁₂)alkyl, more preferably (C₁-C₈)alkyl, more preferably (C₁-C₆)alkyl, more preferably (C₁-C₅)alkyl, more preferably (C₁-C₄)alkyl,
wherein R¹³ and R¹⁴ independently from one another more preferably is methyl, ethyl, propyl, isopropyl, n-butyl, sec-butyl, isobutyl, or tert-butyl, more preferably methyl,
wherein R¹⁶ and R¹⁷ independently from one another is H or alkyl,
wherein R¹⁶ and R¹⁷ independently from one another preferably is H or, optionally branched, preferably linear, (C₁-C₂₂)alkyl, preferably (C₁-C₁₆)alkyl, more preferably (C₁-C₁₂)alkyl, more preferably (C₁-C₈)alkyl, more preferably (C₁-C₆)alkyl, more preferably (C₁-C₅)alkyl, more preferably (C₁-C₄)alkyl,
wherein R¹⁶ and R¹⁷ independently from one another more preferably is H, methyl, ethyl, propyl, isopropyl, n-butyl, sec-butyl, isobutyl, or tert-butyl, more preferably methyl,
wherein R¹⁵ is an optionally branched and/or cyclic alkylene, alkarylene, aralkylene, or arylene,
wherein R¹⁵ is preferably selected from the group consisting of linear or branched (C₁-C₁₆)alkylene, cycloaliphatic (C₅-C₂₀)alkylene, (C₆-C₁₈)arylene, (C₇-C₂₀)aralkylene, and (C₇-C₂₀)alkarylene, preferably selected from the group consisting of (C₁-C₈)alkylene, cycloaliphatic (C₅-C₁₀)alkylene, (C₆-C₉)arylene, (C₇-C₁₅)aralkylene, and (C₇-C₁₅)alkarylene, more preferably selected from the group consisting of (C₁-C₆)alkylene, (C₅-C₆)alkylene, (C₆)arylene, (C₇-C₁₂)aralkylene, and (C₇-C₁₂)alkarylene, more preferably selected from the group consisting of (C₃-C₆)alkylene, (C₇-C₁₀)aralkylene, and (C₇-C₁₀)alkarylene, more preferably selected from the group consisting of (C₇-C₉)aralkylene, and (C₇-C₉)alkarylene, wherein R¹⁵ is more preferably selected from the group consisting of (C₈-C₉)aralkylene, and (C₈-C₉)alkarylene,
wherein R¹⁵ is more preferably selected from the group consisting of methylene, ethylene, trimethylene, tetramethylene, pentamethylene, hexamethylene, ortho-phenylene, meta-phenylene, and para-phenylene,
wherein R¹⁵ more preferably is selected from the group consisting of pentamethylene, hexamethylene, ortho-phenylene, meta-phenylene, and para-phenylene,
wherein R¹⁵ more preferably is para-phenylene,
wherein R¹⁸ is selected from the group consisting of isopropenyl, NCNR¹⁹, NHCONHR²⁰, NHCONR²¹R²², and NHCOOR²³,
wherein R¹⁹ is (C₁-C₁₈)alkylene, (C₅-C₁₈)cycloalkylene, arylene, (C₇-C₁₈)alkarylene and/or (C₇-C₁₈)aralkylene, preferably (C₇-C₁₈)alkylarylene and/or (C₇-C₁₈)aralkylene, wherein R²⁰, R²¹, R²², and R²³ independently from one another is selected from the group consisting of alkyl, cycloalkyl, alkaryl, aralkyl, a polyester group, a polyamide group, and —(CH₂)ₕ—O—[(CH₂)ₖ—O]_{g}—R²⁴,
wherein h is in the range of from 1 to 3, k is in the range of from 1 to 3, g is in the range of from 0 to 12, and wherein R²⁴ is H or (C₁-C₄)alkyl,
wherein R²⁰, R²¹, R²², and R²³ independently from one another is preferably selected from the group consisting of optionally branched and/or cyclic, preferably linear, (C₁-C₁₂)alkyl, cycloaliphatic (C₅-C₁₀)alkyl, (C₆-C₉)aryl, (C₇-C₁₅)aralkyl, and (C₇-C₁₅)alkaryl, more preferably selected from the group consisting of optionally branched and/or cyclic, preferably linear, (C₁-C₈)alkyl, cycloaliphatic (C₅-C₆)alkyl, (C₆-C₉)aryl, (C₇-C₁₂)aralkyl, and (C₇-C₁₂)alkaryl,
more preferably selected from the group consisting of optionally branched and/or cyclic, preferably linear, (C₁-C₆)alkyl, cycloaliphatic (C₅-C₆)alkyl, and (C₆)aryl,
more preferably selected from the group consisting of optionally branched and/or cyclic, preferably linear, (C₁-C₅)alkyl,
more preferably selected from the group consisting of optionally branched and/or cyclic, preferably linear, (C₁-C₄)alkyl,
wherein preferably R²⁰, R²¹, R²², and R²³ independently from one another is methyl, ethyl, propyl, isopropyl, n-butyl, sec-butyl, isobutyl, or tert-butyl.

A preferred embodiment (28) concretizing embodiment (27) relates to said process, wherein R²³ is O—(R²⁸—O)ₘ—R²⁹,
wherein R²⁸ is an alkylene group,
wherein R²⁸ is preferably selected from the group consisting of methylene, ethylene, trimethylene, tetramethylene, pentamethylene, hexamethylene, ortho-phenylene, meta-phenylene, para-phenylene,
wherein R²⁸ more preferably is ethylene,
wherein R²⁹ more preferably is, optionally branched, preferably linear, (C₁-C₂₂)alkyl, preferably (C₁-C₁₈)alkyl, more preferably partially unsaturated (C₁-C₁₈)alkyl, more preferably (C₁-C₁₆)alkyl, more preferably (C₁-C₁₂)alkyl, more preferably (C₁-C₈)alkyl, more preferably (C₁-C₆)alkyl, more preferably (C₁-C₅)alkyl, more preferably (C₁-C₄)alkyl,
wherein R²⁹ more preferably is methyl, ethyl, propyl, isopropyl, n-butyl, sec-butyl, isobutyl, or tert-butyl, more preferably methyl, and
wherein m is an integer of 0 to 150, preferably an integer of 2 to 150, preferably an integer of 5 to 100, more preferably an integer of 7 to 50, more preferably an integer of 8 to 25, more preferably an integer of 9 to 20, more preferably an integer of 10 to 15.

A preferred embodiment (29) concretizing embodiment (28) relates to said process, wherein R²⁹ is a substituted alkyl group, wherein the substituted alkyl group preferably comprises one or more substituents, wherein the one or more substituents of the substituted alkyl group are preferably selected from the group consisting of (C₁-C₃)alkoxy, hydroxyl, amino, halides, and combinations of two or more thereof, more preferably from the group consisting of (C₁-C₂)alkoxy, hydroxyl, amino, chloro, bromo, fluoro, and combinations of two or more thereof, more preferably from the group consisting of hydroxyl, amino, chloro, and combinations thereof, wherein more preferably the one or more substituents is hydroxyl,
wherein the substituted alkyl group preferably comprises one or more substituents, preferably 1 to 4 substituents, more preferably 1 to 3 substituents, more preferably 1 or 2 substituents, wherein the substituted alkyl group more preferably comprises 1 substituent.

A preferred embodiment (30) concretizing embodiment (28) or (29) relates to said process, wherein R²⁹ is a partially unsaturated alkyl group, wherein R²⁹ preferably comprises one or more, more preferably from 1 to 5, more preferably from 1 to 3, more preferably one, C—C double bonds.

A preferred embodiment (31) concretizing any one of embodiments (28) to (30) relates to said process, wherein n=0,
wherein R²⁹ preferably is optionally partially unsaturated and/or optionally substituted (C₁-C₂₂)alkyl, preferably (C₁₂-C₂₂)alkyl, more preferably partially unsaturated (C₁₂-C₂₂)alkyl, more preferably partially unsaturated (C₁₆-C₂₀)alkyl, more preferably partially unsaturated (C₁₈-C₁₉)alkyl, wherein R²⁹ more preferably is partially unsaturated, wherein R²⁹ preferably comprises one or more, more preferably from 1 to 5, more preferably from 1 to 3, more preferably one, C—C double bonds, and wherein R²⁹ more preferably is (Z)-Octadec-9-en-yl (oleyl).

A preferred embodiment (32) concretizing any one of embodiments (1) to (31) relates to said process, wherein the one or more tertiary isocyanates comprised in the mixture according to (i) comprises, preferably consists of, a tertiary monoisocyanate, preferably 3-isopropenyl-alpha,alpha-dimethylbenzyl isocyanate (TMI).

A preferred embodiment (33) concretizing any one of embodiments (1) to (32) relates to said process, wherein the reaction conditions in (ii) comprise heating the mixture obtained in (i) at a temperature in the range of from 50 to 220° C., preferably in the range of from 60 to 200° C., more preferably in the range of from 70 to 160° C., more preferably in the range of from 80 to 140° C.

A preferred embodiment (34) concretizing any one of embodiments (1) to (33) relates to said process, wherein the gas atmosphere in (ii) comprises, preferably consists of, an inert gas, wherein the gas atmosphere in (ii) preferably comprises, more preferably consists of, one or more of nitrogen and argon.

A preferred embodiment (35) concretizing any one of embodiments (1) to (34) relates to said process, wherein the reaction conditions in (ii) comprise applying a pressure to the reaction mixture obtained in (i) in the range of from 1 to 1000 hPa, preferably in the range of from 2 to 1000 hPa, more preferably in the range of from 2.5 to 1000 hPa, to the reaction mixture obtained in (i).

A preferred embodiment (36) concretizing any one of embodiments (1) to (35) relates to said process, wherein the reaction conditions in (ii) comprise agitating the mixture obtained in (i), preferably by stirring.

A preferred embodiment (37) concretizing any one of embodiments (1) to (36) relates to said process, wherein the mixture obtained in (i) is subjected to reaction conditions in (ii) for a duration in the range of from 1 to 50 h, preferably in the range of from 1.5 to 40 h, more preferably in the range of from to 2 to 25 h.

A preferred embodiment (38) concretizing any one of embodiments (1) to (37) relates to said process, wherein the reactor according to (i) comprises one or more of a reactor vessel and a tubular reactor.

A preferred embodiment (39) concretizing any one of embodiments (1) to (38) relates to said process, wherein the mixture provided in (i) further comprises a first end-capping agent, wherein the first end-capping agent has the formula (III):

HO—(R¹¹—O)ₙ—R¹² (III),
wherein R¹¹ is an alkylene group,
wherein R¹¹ is preferably selected from the group consisting of methylene, ethylene, trimethylene, tetramethylene, pentamethylene, hexamethylene, ortho-phenylene, meta-phenylene, para-phenylene,
wherein R¹¹ more preferably is ethylene,
wherein R¹² more preferably is, optionally branched, preferably linear, (C₁-C₂₂)alkyl, preferably (C₁-C₁₈)alkyl, more preferably partially unsaturated (C₁-C₁₈)alkyl, more preferably (C₁-C₁₆)alkyl, more preferably (C₁-C₁₂)alkyl, more preferably (C₁-C₈)alkyl, more preferably (C₁-C₆)alkyl, more preferably (C₁-C₅)alkyl, more preferably (C₁-C₄)alkyl,
wherein R¹² more preferably is methyl, ethyl, propyl, isopropyl, n-butyl, sec-butyl, isobutyl, or tert-butyl, more preferably methyl, and
wherein n is an integer of 0 to 150, preferably an integer of 2 to 150, preferably an integer of 5 to 100, more preferably an integer of 7 to 50, more preferably an integer of 8 to 25, more preferably an integer of 9 to 20, more preferably an integer of 10 to 15,
wherein the first end-capping agent according to (iv) more preferably is a methylpolyethylene glycol.

A preferred embodiment (40) concretizing embodiment (39) relates to said process, wherein R¹² is a substituted alkyl group, wherein the substituted alkyl group preferably comprises one or more substituents, wherein the one or more substituents of the substituted alkyl group are preferably selected from the group consisting of (C₁-C₃)alkoxy, hydroxyl, amino, halides, and combinations of two or more thereof, more preferably from the group consisting of (C₁-C₂)alkoxy, hydroxyl, amino, chloro, bromo, fluoro, and combinations of two or more thereof, more preferably from the group consisting of hydroxyl, amino, chloro, and combinations thereof, wherein more preferably the one or more substituents is hydroxyl, wherein the substituted alkyl group preferably comprises one or more substituents, preferably 1 to 4 substituents, more preferably 1 to 3 substituents, more preferably 1 or 2 substituents, wherein the substituted alkyl group more preferably comprises 1 substituent.

A preferred embodiment (41) concretizing embodiment (39) or (40) relates to said process, wherein R¹² is a partially unsaturated alkyl group, wherein R¹² preferably comprises one or more, more preferably from 1 to 5, more preferably from 1 to 3, more preferably one, C—C double bonds.

A preferred embodiment (42) concretizing any one of embodiments (39) to (41) relates to said process, wherein n=0,
wherein R¹² preferably is optionally partially unsaturated and/or optionally substituted (C₁-C₂₂)alkyl, preferably (C₁₂-C₂₂)alkyl, more preferably partially unsaturated (C₁₂-C₂₂)alkyl, more preferably partially unsaturated (C₁₆-C₂₀)alkyl, more preferably partially unsaturated (C₁₈-C₁₉)alkyl, wherein R¹² more preferably is partially unsaturated, wherein R¹² preferably comprises one or more, more preferably from 1 to 5, more preferably from 1 to 3, more preferably one, C═C double bonds, and wherein R¹² more preferably is (Z)-Octadec-9-en-yl (oleyl).

A preferred embodiment (43) concretizing any one of embodiments (39) to (42) relates to said process, wherein the first end-capping agent has an average molar mass in the range of from 100 to 5500 g/mol, preferably in the range of from 200 to 3300 g/mol, more preferably in the range of from 300 to 2200 g/mol, more preferably in the range of from 400 to 1100 g/mol, more preferably in the range of from 400 to 800 g/mol, more preferably in the range of from 450 to 550 g/mol.

A preferred embodiment (44) concretizing any one of embodiments (39) to (43) relates to said process, wherein the first end-capping agent according to (iv) exhibits a hydroxyl number in the range of from 5 to 200 mg (KOH)/g, preferably in the range of from 15 to 175 mg (KOH)/g, more preferably in the range of from 45 to 145 mg (KOH)/g, more preferably in the range of from 75 to 130 mg (KOH)/g, more preferably in the range of from 100 to 120 mg (KOH)/g, wherein the hydroxyl number is preferably determined according to DIN 53240.

A preferred embodiment (45) concretizing any one of embodiments (39) to (44) relates to said process, wherein the first end-capping agent exhibits viscosity in the range of from 5 to 200 mm²/s, preferably in the range of from 15 to 175 mm²/s, more preferably in the range of from 45 to 145 mm²/s, more preferably in the range of from 75 to 130 mm²/s, more preferably in the range of from 100 to 120 mm²/s, wherein the viscosity is preferably determined at a temperature in the range of from 15 to 25° C., more preferably at a temperature of 19 to 21° C., more preferably at a temperature of 20° C., wherein the viscosity is more preferably determined according to DIN 51562.

A preferred embodiment (46) concretizing any one of embodiments (39) to (45) relates to said process, wherein the first end-capping agent comprises equal to or less than 1 weight-%, preferably equal to or less than 0.6 weight-%, more preferably of equal to or less than 0.55 weight %, of water, based on 100 weight-% of the first end-capping agent, wherein the water content is preferably determined according to EN 13267.

A preferred embodiment (47) concretizing any one of embodiments (39) to (46) relates to said process, wherein the first end-capping agent is de-ionized.

A preferred embodiment (48) concretizing any one of embodiments (1) to (47) relates to said process, wherein a molar ratio of the one or more tertiary isocyanates comprised in the mixture according to (i), calculated as sum of the molar amounts of the one or more tertiary isocyanates, to the catalytic compound comprised in the mixture according to (i), calculated as molar amount of the cation comprised in the catalytic compound comprised in the mixture according to (i), in the mixture obtained in (i) is in the range of from 0.2:1 to 150:1, preferably in the range of from 0.4:1 to 125:1, more preferably in the range of from to 0.5:1 to 100:1, more preferably in the range of from to 1:1 to 85:1, more preferably in the range of from to 3:1 to 75:1, more preferably in the range of from to 6:1 to 70:1, more preferably in the range of from to 11:1 to 65:1, more preferably in the range of from 13:1 to 62:1.

A preferred embodiment (49) concretizing any one of embodiments (1) to (48) relates to said process, wherein the mixture obtained in (i) comprises the catalytic compound in an amount in the range of from 0.1 to 50 mol-%, preferably in the range of from 0.5 to 20 mol-%, more preferably in the range of from 0.75 to 15 mol-%, more preferably in the range of from 0.80 to 12 mol-%, more preferably in the range of from 1.0 to 10 mol-%, more preferably in the range of from 1.5 to 7.5 mol-%, based on 100 mol-% of the one or more tertiary isocyanates, calculated as sum of the molar amounts of the one or more tertiary isocyanates.

A preferred embodiment (50) concretizing any one of embodiments (1) to (49) relates to said process, wherein the mixture obtained in (i) comprises the catalytic compound in an amount in the range of from 0.5 to 10 weight-%, preferably in the range of from 1 to 7 weight-%, more preferably in the range of from 2 to 5.5 weight-%, more preferably in the range of from 2.5 to 5 weight-%, based on 100 weight-% of the one or more tertiary isocyanates, calculated as sum of the weights of the one or more tertiary isocyanates.

A preferred embodiment (51) concretizing any one of embodiments (1) to (50) relates to said process, wherein the mixture obtained in (i) comprises equal to or less than 25 weight-%, preferably in the range of from 0.1 to 10 weight-%, more preferably in the range of from 1 to 5 weight-%, of xylene, preferably of an alkyl substituted benzene or an alkyl substituted dibenzene, wherein the alkyl comprises one or more of methyl, ethyl, and propyl, more preferably of a solvent, based on 100 weight-% of the mixture obtained in (i),
wherein the mixture obtained in (i) is more preferably essentially free of xylene, more preferably of an alkyl substituted benzene or an alkyl substituted dibenzene, wherein the alkyl comprises one or more of methyl, ethyl, and propyl, more preferably of a solvent.

A preferred embodiment (52) concretizing any one of embodiments (1) to (51) relates to said process, wherein the mixture obtained in (i) comprises equal to or less than 5 weight-%, preferably in the range of from 0.1 to 1 weight-%, of a primary diisocyanate, preferably of a primary isocyanate, based on 100 weight-% of the mixture obtained in (ii), wherein the mixture prepared in (i) is more preferably essentially free of a primary diisocyanate, preferably of a primary isocyanate.

A preferred embodiment (53) concretizing any one of embodiments (1) to (52) relates to said process, wherein the mixture obtained in (i) comprises equal to or less than 5 weight-%, preferably in the range of from 0.1 to 1 weight-%, of a secondary diisocyanate, preferably of a secondary isocyanate, based on 100 weight-% of the mixture obtained in (ii), wherein the mixture prepared in (i) is more preferably essentially free of a secondary diisocyanate, preferably of a secondary isocyanate.

A preferred embodiment (54) concretizing any one of embodiments (1) to (53) relates to said process, wherein the mixture obtained in (ii) comprises equal to or less than 35 mol-%, preferably in the range of from 1 to 20 mol-%, more preferably in the range of from 5 to 15 mol-%, of the one or more tertiary isocyanates, based on 100 mol-% of the one or more tertiary isocyanates, calculated as sum of the molar amounts of the one or more tertiary isocyanates, comprised in the mixture according to (i).

A preferred embodiment (55) concretizing any one of embodiments (1) to (54) relates to said process, wherein the process further comprises
(c) cooling the mixture obtained in (ii) to a temperature in the range of from 0 to less than 45° C., preferably in the range of from 10 to 25° C., for inhibiting further carbodiimidization, preferably for inhibiting further reaction.

A preferred embodiment (56) concretizing any one of embodiments (1) to (55) relates to said process, wherein the process further comprises
(iii) subjecting the mixture obtained in (ii) or (c) to distillation conditions, wherein the distillation conditions comprise heating the mixture obtained in (ii) or (c) at the boiling point of the one or more tertiary isocyanates comprised in the mixture obtained in (i) in a gas atmosphere; for separating at least a portion of the one or more tertiary isocyanates from the mixture, and preferably for degradation of at least a portion of the catalytic compound.

A preferred embodiment (57) concretizing embodiment (56) relates to said process, wherein the distillation conditions comprise heating the mixture obtained in (ii) or (c) at a temperature in the range of from 170 to 210° C., preferably in the range of from 180 to 200° C.

A preferred embodiment (58) concretizing embodiment (56) or (57) relates to said process, wherein the distillation conditions comprise applying a pressure to the reaction mixture obtained in (ii) or (c) in the range of from 1 to 250 hPa, preferably in the range of from 5 to 150 hPa, more preferably in the range of from 5 to 10 hPa.

A preferred embodiment (59) concretizing any one of embodiments (56) to (58) relates to said process, wherein the mixture obtained in (iii) comprises equal to or less than 10.5 weight-%, preferably equal to or less than 8.0 weight-%, of isocyanate groups NCO, based on 100 weight-% of the weight of the mixture obtained in (iii).

A preferred embodiment (60) concretizing any one of embodiments (56) to (59) relates to said process, wherein the process further comprises
(r) recycling a portion of the one or more tertiary isocyanates obtained in (iii) into (i).

A preferred embodiment (61) concretizing any one of embodiments (1) to (60) relates to said process, wherein the process further comprises
(d) subjecting the mixture obtained in (ii), (c) or (iii), preferably the mixture obtained in (iii), to degradation conditions in a gas atmosphere, for degradation of at least a portion of the catalytic compound,
   wherein the process preferably comprises (iv) and wherein the degradation conditions are the same as the distillation conditions in (iii).

A preferred embodiment (62) concretizing embodiment (61) relates to said process, wherein the degradation conditions comprise heating the mixture obtained in (ii), (c) or (iii) at a temperature in the range of from 100 to 220° C., preferably in the range of from 120 to 200° C., more preferably in the range of from 160 to 195° C.

A preferred embodiment (63) concretizing embodiment (61) or (62) relates to said process, wherein the degradation conditions comprise applying a pressure to the reaction mixture obtained in (ii), (c) or (iii) in the range of from 1 to 250 hPa, preferably in the range of from 5 to 150 hPa, more preferably in the range of from 5 to 10 hPa.

A preferred embodiment (64) concretizing any one of embodiments (61) to (63) relates to said process, wherein the gas atmosphere in (d) comprises, preferably consists of, an inert gas, wherein the gas atmosphere in (d) preferably comprises, more preferably consists of, one or more of nitrogen and argon.

A preferred embodiment (65) concretizing any one of embodiments (1) or (64) relates to said process, wherein the process further comprises
(iv) mixing the carbodiimide and/or polycarbodiimide obtained in (ii), (c), (iii) or (d) with a second end-capping agent;
(v) subjecting the mixture obtained in (iv) in a gas atmosphere to end-capping conditions, for obtaining a carbodiimide and/or a polycarbodiimide comprising one or more end-caps; wherein the second end-capping agent according to (iv) preferably comprises one hydroxyl group.

A preferred embodiment (66) concretizing embodiment (65) relates to said process, wherein the second end-capping agent according to (iv) has the formula (IV):

HO—(R²⁵—O)ₙ—R²⁶ (IV),
wherein R²⁵ is an alkylene group,
wherein R²⁵ is preferably selected from the group consisting of methylene, ethylene, trimethylene, tetramethylene, pentamethylene, hexamethylene, ortho-phenylene, meta-phenylene, para-phenylene,
wherein R²⁵ more preferably is ethylene,
wherein R²⁶ is an optionally partially unsaturated and/or optionally substituted alkyl group, wherein R²⁶ more preferably is, optionally branched, preferably linear, (C₁-C₂₂)alkyl, preferably (C₁-C₁₈)alkyl, more preferably partially unsaturated (C₁-C₁₈)alkyl, more preferably (C₁-C₁₆)alkyl, more preferably (C₁-C₁₂)alkyl, more preferably (C₁-C₈)alkyl, more preferably (C₁-C₆)alkyl, more preferably (C₁-C₅)alkyl, more preferably (C₁-C₄)alkyl,
wherein R²⁶ more preferably is methyl, ethyl, propyl, isopropyl, n-butyl, sec-butyl, isobutyl, or tert-butyl, more preferably methyl, and
wherein n is an integer of 0 to 150, preferably an integer of 2 to 150, preferably an integer of 5 to 100, more preferably an integer of 7 to 50, more preferably an integer of 8 to 25, more preferably an integer of 9 to 20, more preferably an integer of 10 to 15,
wherein the second end-capping agent according to (iv) more preferably is a methylpolyethylene glycol.

A preferred embodiment (67) concretizing embodiment (66) relates to said process, wherein R²⁶ is a substituted alkyl group, wherein the substituted alkyl group preferably comprises one or more substituents, wherein the one or more substituents of the substituted alkyl group are preferably selected from the group consisting of (C₁-C₃)alkoxy, hydroxyl, amino, halides, and combinations of two or more thereof, more preferably from the group consisting of (C₁-C₂)alkoxy, hydroxyl, amino, chloro, bromo, fluoro, and combinations of two or more thereof, more preferably from the group consisting of hydroxyl, amino, chloro, and combinations thereof, wherein more preferably the one or more substituents is hydroxyl, wherein the substituted alkyl group preferably comprises one or more substituents, preferably 1 to 4 substituents, more preferably 1 to 3 substituents, more preferably 1 or 2 substituents, wherein the substituted alkyl group more preferably comprises 1 substituent.

A preferred embodiment (68) concretizing embodiment (66) or (67) relates to said process, wherein R²⁶ is a partially unsaturated alkyl group, wherein R²⁶ preferably comprises one or more, more preferably from 1 to 5, more preferably from 1 to 3, more preferably one, C—C double bonds.

A preferred embodiment (69) concretizing any one of embodiments (66) to (68) relates to said process, wherein n=0,
wherein R²⁶ preferably is optionally partially unsaturated and/or optionally substituted (C₁-C₂₂)alkyl, preferably (C₁₂-C₂₂)alkyl, more preferably partially unsaturated (C₁₂-C₂₂)alkyl, more preferably partially unsaturated (C₁₆-C₂₀)alkyl, more preferably partially unsaturated (C₁₈-C₁₉)alkyl, wherein R²⁶ more preferably is partially unsaturated, wherein R²⁶ preferably comprises one or more, more preferably from 1 to 5, more preferably from 1 to 3, more preferably one, C═C double bonds, and wherein R²⁶ more preferably is (Z)-Octadec-9-en-yl (oleyl).

A preferred embodiment (70) concretizing any one of embodiments (65) to (69) relates to said process, wherein the second end-capping agent according to (iv) has an average molar mass in the range of from 100 to 5500 g/mol, preferably in the range of from 200 to 3300 g/mol, more preferably in the range of from 300 to 2200 g/mol, more preferably in the range of from 400 to 1100 g/mol, more preferably in the range of from 400 to 800 g/mol, more preferably in the range of from 450 to 550 g/mol.

A preferred embodiment (71) concretizing any one of embodiments (65) to (70) relates to said process, wherein the second end-capping agent according to (iv) exhibits a hydroxyl number in the range of from 5 to 200 mg (KOH)/g, preferably in the range of from 15 to 175 mg (KOH)/g, more preferably in the range of from 45 to 145 mg (KOH)/g, more preferably in the range of from 75 to 130 mg (KOH)/g, more preferably in the range of from 100 to 120 mg (KOH)/g, wherein the hydroxyl number is preferably determined according to DIN 53240.

A preferred embodiment (72) concretizing any one of embodiments (65) to (71) relates to said process, wherein the second end-capping agent according to (iv) exhibits viscosity in the range of from 5 to 200 mm²/s, preferably in the range of from 15 to 175 mm²/s, more preferably in the range of from 45 to 145 mm²/s, more preferably in the range of from 75 to 130 mm²/s, more preferably in the range of from 100 to 120 mm²/s, wherein the viscosity is preferably determined at a temperature in the range of from 15 to 25° C., more preferably at a temperature of 19 to 21° C., more preferably at a temperature of 20° C., wherein the viscosity is more preferably determined according to DIN 51562.

A preferred embodiment (73) concretizing any one of embodiments (65) to (72) relates to said process, wherein the second end-capping agent according to (iv) comprises equal to or less than 1 weight-%, preferably equal to or less than 0.6 weight-%, more preferably of equal to or less than 0.55 weight-%, of water, based on 100 weight-% of the second end-capping agent, wherein the water content is preferably determined according to EN 13267.

A preferred embodiment (74) concretizing any one of embodiments (65) to (73) relates to said process, wherein the second end-capping agent according to (iv) is de-ionized.

A preferred embodiment (75) concretizing any one of embodiments (65) to (74) relates to said process, wherein the mixture obtained in (v) comprises from 55 to 85 weight-%, preferably from 60 to 80 weight-%, more preferably from 65 to 75 weight-%, of the second end-capping agent, based on 100 weight-% of the polycarbodiimide obtained in (ii), (iii) or (d).

A preferred embodiment (76) concretizing any one of embodiments (65) to (75) relates to said process, wherein the gas atmosphere in (v) comprises, preferably consists of, an inert gas, wherein the gas atmosphere in (v) preferably comprises, more preferably consists of, one or more of nitrogen and argon.

A preferred embodiment (77) concretizing any one of embodiments (65) to (76) relates to said process, wherein the end-capping conditions according to (v) comprise heating the mixture obtained in (iv) to a temperature in the range of from 80 to 160° C., preferably in the range of from 100 to 140° C., more preferably in the range of from 110 to 130° C.

A preferred embodiment (78) concretizing any one of embodiments (65) to (77) relates to said process, wherein the mixture obtained in (iv) is subjected to end-capping conditions according to (v) for a duration in the range of from 1 to 10 h, preferably in the range of from 3 to 7 h, more preferably in the range of from 4 to 6 h.

A preferred embodiment (79) concretizing any one of embodiments (65) to (78) relates to said process, wherein the carbodiimide and/or polycarbodiimide being end-capped obtained in (v) comprises equal to or less than 0.1 weight-%, preferably equal to or less than 0.01 weight-%, more preferably equal to or less than 0.001 weight-%, of isocyanate groups NCO, based on 100 weight-% of the mixture obtained in (v).

A preferred embodiment (80) concretizing any one of embodiments (1) to (79) relates to said process, wherein the process further comprises
(vi) isolating the carbodiimide and/or polycarbodiimide, from the mixture obtained in (ii), (c), (iii), (v) or (d).

According to an embodiment (81), the present invention further relates to a carbodiimide and/or a polycarbodiimide as obtained and/or obtainable by the process according to any one of embodiments (1) to (80).

A preferred embodiment (82) concretizing embodiment (81) relates to said carbodiimide and/or polycarbodiimide, wherein the carbodiimide and/or polycarbodiimide comprises at least 1, preferably from 1 to 30, more preferably from 2 to 15, carbodiimide groups.

According to an embodiment (83), the present invention further relates to a use of a carbodiimide and/or polycarbodiimide according to embodiment (81) or (82) as a stabilizer, preferably as a hydrolysis stabilizer, for a polymer, more preferably for a thermoplastic polymer, more preferably for a thermoplastic polyester, more preferably for one or more of a polyurethane (PU), preferably a thermoplastic polyurethane (TPU), a polyurea, a polyethylene terephthalate (PET), a polybutylene terephthalate (PBT), a polyactide (PLA), a polyamide, a polyesteramide, a polycaprolactone, and a polyethersulfone (PES).

The carbodiimide and/or polycarbodiimide preparation can be carried out in the absence or presence of solvents which are inert under the reaction conditions. It is preferred, however, that no solvent is used.

The carbodiimides and/or polycarbodiimides of the present invention comprise at least one, preferably from 1 to 30, more preferably from 2 to 15, carbodiimide group(s); the mean degree of condensation (number average), i. e. the mean number of carbodiimide groups in the polycarbodiimides of the present invention, is particularly preferably from 1 to 10.

The carbodiimide groups of the carbodiimides and polycarbodiimides of the present invention are bound to non-aromatic carbon atoms. This offers the significant advantage that no aromatic amines are liberated on possible cleavage of the carbodiimides. The carbodiimides and polycarbodiimides of the present invention are therefore of less toxicological concern.

In the context of the present invention, a tertiary monoisocyanate is a compound comprising one isocyanate group NCO, wherein said isocyanate group is connected to a tertiary carbon atom. Similarly, a primary monoisocyanate is a compound comprising one isocyanate group NCO, wherein said isocyanate group is connected to a primary carbon atom. Similarly, a secondary monoisocyanate is a compound comprising one isocyanate group NCO, wherein said isocyanate group is connected to a secondary carbon atom.

Further, a tertiary diisocyanate is a compound comprising two isocyanate groups NCO, wherein each of said isocyanate groups is connected to a tertiary carbon atom. Similarly, a primary diisocyanate is a compound comprising two isocyanate groups NCO, wherein each of said isocyanate groups is connected to a primary carbon atom. Similarly, a secondary diisocyanate is a compound comprising two isocyanate groups NCO, wherein each of said isocyanate groups is connected to a secondary carbon atom.

Thus, in the context of the present invention, an isocyanate compound comprising two or more isocyanate groups NCO, wherein at least one of said isocyanate groups is connected to a primary carbon atom or to a secondary carbon atom, is not considered as a tertiary diisocyanate. In the context of the present invention, an alkyl group consists of carbon atoms and hydrogen atoms. Thus, an alkyl group according to the present invention does not comprise a further substituent, e. g. a hydroxyl or chloride group, unless otherwise defined.

Furthermore, a carboxylate anion [R⁵—COO]⁻ in the context of the present invention includes hydrogen carbonate [HO—COO]⁻, corresponding to a carboxylate anion [R⁵—COO]⁻ wherein R⁵ is hydroxide.

The present invention is further illustrated by the following reference examples, examples, and comparative examples.

### EXAMPLES

### Reference Example 1: Determination of FTIR Spectra and ATR-FTIR Spectra

FTIR spectra, in particular for determination of characteristic bands for isocyanate groups, were recorded via single reflection ATR module on a Eco-ATR from Brücker. A sample was added directly onto the ATR crystal without any modification. Typically, it is expected that an isocyanate group NCO shows a band at about 2200 cm⁻¹ in the FTIR spectrum and that a carbodiimide group shows a band at about 2100 cm⁻¹.

### Reference Example 2: Preparation of Tetrabutylammonium 2-Ethylhexanoate

25 g tetrabutylammonium chloride (163 mmol) were dissolved in 70 g water. Ion exchange resin (Ambersep 900; OH-Form; capacity of 0.8 mol-eq./ml) was filled into a glass column equipped with a valve. The ion exchange resin was washed with MeOH and then with de-ionized water until the pH of the washing water was neutral. The aqueous tetrabutylammonium chloride-containing solution (approx. 140 ml) was ion exchanged over (approx. 250 ml, 200 mmol; 1.22 eq.) the ion exchange resin to exchange chloride against hydroxide. The resulting basic solution (approx. 700 ml) was neutralized with 2-ethylhexanoic acid (controlled by pH change). The stabilization of the pH value took longer since 2-ethylhexanoic acid dissolves only slowly in water. Isopropyl alcohol (200 ml twice; azeotropic distillation) is added to the aqueous solution and the resulting mixture was concentrated on a rotary evaporator (2 mbar; temperature of water bath: 30° C.).

### Reference Example 3: Preparation of Tributylmethylammonium 2-Ethylhexanoate

The procedure according to Reference Example 2 was followed whereby tributylmethylammonium chloride was used as starting material, instead of tetrabutylammonium chloride.

### Reference Example 4: Preparation of Tetramethylammonium 2-Ethylhexanoate

The procedure according to Reference Example 2 was followed whereby tetramethylammonium chloride was used as starting material, instead of tetrabutylammonium chloride.

### Example 1: Preparation of a Polycarbodiimide Using Tetramethylammonium Acetate

150.0 g tetramethylxylene diisocyanate (TMXDI; Allnex; 0.614 mol) and 6.0 g tetramethylammonium acetate (Sigma Aldrich; 45 mmol) were charged into a 250 ml, 4-neck round bot tom flask equipped with a thermometer (coupled with a temperature regulated oil-bath), mechanical stirring, a cold-water condenser and nitrogen inlet. The reaction mixture was stirred and heated at 100° C. After approximately five hours the NCO content reached a value of 25.6% and the FTIR spectrum showed a band at 2100 cm⁻¹ corresponding to carbodiimide. After additional 35 hours under the same conditions the NCO content reached a value of 13.7%. FTIR analysis showed a strong carbodiimide band at 2100 cm⁻¹ and the integration of the bands showed that more than 90 mol % of the isocyanate groups were converted into carbodiimide.

The reaction mixture was then distillated for two hours (using a bridge) at 190° C. and 100 mbar for removing unreacted TMXDI and removing decomposition products of thermally degraded catalyst. The resulting product had an NCO content of 7.4%. Approximately 27 g of TMXDI were recovered.

Subsequently, 88.0 g methyl polyethylene glycol (Pluriol A500E; BASF SE; having an average weight of 500 g/mol) were added and reacted via a urethane reaction. After five hours at 120° C., the NCO content reached 0.0%. Then, the reaction mixture was cooled down to room temperature. The FTIR spectrum showed no isocyanate peak around 2200 cm⁻¹ anymore.

### Example 2: Preparation of a Polycarbodiimide Using Tributylmethylammonium 2-Ethylhexanoate

150.0 g tetramethylxylene diisocyanate (TMXDI; Allnex; 0.614 mol) and 4.5 g tetramethylammonium 2-ethylhexanoate (13 mmol) were charged into a 250 ml, 4-neck round bottom flask equipped with a thermometer (coupled with a temperature regulated oil-bath), mechanical stirring, a cold-water condenser and nitrogen inlet. The reaction mixture was stirred and heated at 100° C. After approximately three hours the NCO content reached a value of 11.3% and the FTIR spectrum showed a strong band at 2100 cm⁻¹ corresponding to carbodiimide. The integration of the bands showed that more than 90 mol % of the isocyanate groups were converted into carbodiimide.

The reaction mixture was then distillated for two hours (using a bridge) at 190° C. and 100 mbar for removing unreacted TMXDI and removing decomposition products of thermally degraded catalyst. The resulting product had an NCO content of 5.4%.

Subsequently, 70.2 g methyl polyethylene glycol (Pluriol A500E; BASF SE; having an average weight of 500 g/mol) were added and reacted via a urethane reaction. After five hours at 120° C., the NCO content reached 0.0%. Then, the reaction mixture was cooled down to room temperature. The FTIR spectrum showed no isocyanate peak around 2200 cm⁻¹ anymore.

### Example 3: Preparation of a Polycarbodiimide Using Tetrabutylammonium Acetate

100.0 g tetramethylxylene diisocyanate (TMXDI; Allnex; 0.41 mol) and 5.0 g tetrabutylammonium acetate (17 mmol) were charged into a 250 ml, 4-neck round bottom flask equipped with a thermometer (coupled with a temperature regulated oil-bath), mechanical stirring, a cold-water condenser and nitrogen inlet. The reaction mixture was stirred and heated at 100° C. After approximately 20 hours the NCO content reached a value of 15.0% and the FTIR spectrum showed a strong band at 2100 cm⁻¹ corresponding to carbodiimide.

The reaction mixture was then distillated for 2 hours (using a bridge) at 190° C. and 100 mbar for removing unreacted TMXDI and removing decomposition products of thermally degraded catalyst. The resulting product had an NCO content of 10.4%.

Subsequently, 74.5 g methyl polyethylene glycol (Pluriol A500E; BASF SE; having an average weight of 500 g/mol) were added and reacted via a urethane reaction. After 5 hours at 120° C., the NCO content reached 0.0%. Then, the reaction mixture was cooled down to room temperature. The FTIR spectrum showed no isocyanate peak around 2200 cm⁻¹ anymore.

### Example 4: Preparation of a Polycarbodiimide Using Tetrabutylammonium 2-Ethylhexanoate

81.25 g tetramethylxylene diisocyanate (TMXDI; Allnex; 0.33 mol) and 2.1 g tetrabutylammonium 2-ethylhexanoate (5 mmol) were charged into a 250 ml, 4-neck round bottom flask equipped with a thermometer (coupled with a temperature regulated oil-bath), mechanical stirring, a cold-water condenser and nitrogen inlet. The reaction mixture was stirred and heated at 100° C. After approximately 15 hours the NCO content reached a value of 8.2% and the FTIR spectrum showed a strong band at 2100 cm⁻¹ corresponding to carbodiimide. The integration of the bands showed that more than 90 mol % of the isocyanate groups were converted into carbodiimide.

The reaction mixture was then distillated for 2 hours (using a bridge) at 190° C. and 100 mbar for removing unreacted TMXDI and removing decomposition products of thermally degraded catalyst. The resulting product had an NCO content of 7.4%.

Subsequently, 60.9 g methyl polyethylene glycol (Pluriol A500E; BASF SE; having an average weight of 500 g/mol) were added and reacted via a urethane reaction. After 5 hours at 120° C., the NCO content reached 0.0%. Then, the reaction mixture was cooled down to room temperature. The FTIR spectrum showed no isocyanate peak around 2200 cm⁻¹ anymore.

### Example 5: Preparation of a Polycarbodiimide Using Tetrabutylammonium Acetate

100.0 g tetramethylxylene diisocyanate (TMXDI; Allnex; 0.41 mol) and 4.0 g tetrabutylammonium acetate (17 mmol) were charged into a 250 ml, 4-neck round bottom flask equipped with a thermometer (coupled with a temperature regulated oil-bath), mechanical stirring, a cold-water condenser and nitrogen inlet. The reaction mixture was stirred and heated at 100° C. After approximately 34 hours the NCO content reached a value of 16.1% and the FTIR spectrum showed a strong band at 2100 cm⁻¹ corresponding to carbodiimide.

The reaction mixture was then distillated for 2 hours (using a bridge) at 180° C. and 1 mbar for removing unreacted TMXDI and removing decomposition products of thermally degraded catalyst. The resulting product had an NCO content of 13.9%.

Subsequently, 54.4 g Oleylalcohol were added and reacted via a urethane reaction. After 3 hours at 120° C., the NCO content reached 0.0%. Then, the reaction mixture was cooled down to room temperature. The FTIR spectrum showed no isocyanate peak around 2200 cm⁻¹ any more.

### Example 6: Preparation of a Polycarbodiimide Using Tetramethylammonium Acetate

100.0 g tetramethylxylene diisocyanate (TMXDI; Allnex; 0.41 mol) and 100.0 g methylpolyethylene glycol (Pluriol A500E; BASF SE; having an average weight of 500 g/mol) were charged into a 250 ml, 4-neck round bottom flask equipped with a thermometer (coupled with a temperature regulated oil-bath), mechanical stirring, a cold-water condenser and nitrogen inlet. The reaction mixture was stirred and heated at 100° C. After approximately 3 hours the NCO content reached a value of 13.0% (the urethane reaction was complete), Subsequently, 5.5 g tetramethylammonium acetate (Sigma Aldrich; 41.3 mmol) were added and the temperature increased to 110° C. After 50 hours, the NCO content reached 0.0 wt %. Then, the reaction mixture was cooled down to room temperature. The FTIR spectrum showed no isocyanate peak around 2200 cm⁻¹ anymore and a strong band at 2100 cm⁻¹ corresponding to carbodiimide was observed.

### Comparative Example 7: Preparation of a Polycarbodiimide Using Potassium Acetate

A polycarbodiimide was prepared according to WO 2019/176919 A1.

150.0 g tetramethylxylene diisocyanate (TMXDI; Allnex; 0.614 mol) and 4.5 g potassium acetate (Sigma Aldrich; 46 mmol) were charged into a 250 ml, 4-neck round bottom flask equipped with a thermometer (coupled with a temperature regulated oil-bath), mechanical stirring, a cold-water condenser and nitrogen inlet. The reaction mixture was stirred and heated at 100° C. After approximately two hours the NCO content was determined to be 33.0 weight-%. After further eight hours under the same conditions, the NCO content was determined to be still 33.0 weight-% indicating that no reaction took place. The FTIR spectrum of the resulting mixture did not show carbodiimide bands at 2100 cm⁻¹.

### Comparative Example 8: Preparation of a Polycarbodiimide Using Cesium Carbonate

A polycarbodiimide was prepared according to WO 2016/202781 A1.

150.0 g tetramethylxylene diisocyanate (TMXDI; Allnex; 0.614 mol) and 4.5 g Cs₂CO₃ (Sigma Aldrich; 14 mmol) were charged into a 250 ml, 4-neck round bottom flask equipped with a thermometer (coupled with a temperature regulated oil-bath), mechanical stirring, a cold-water con denser and nitrogen inlet. The reaction mixture was stirred and heated at 100° C. After approximately two hours the NCO content was determined to be 33.0 weight-%. After further eight hours under the same conditions, the NCO content was determined to be still 33.0 weight-% indicating that no reaction took place. The FTIR spectrum of the resulting mixture was performed did not show carbodiimide bands at 2100 cm⁻¹.

### Comparative Example 9: Preparation of a Polycarbodiimide Using a Secondary Diisocyanate (H₁₂MDI)

10 g of hydrogenated MDI (also designated as H₁₂MDI or 4,4′-diisocyanato dicyclohexylmethane; Desmodur W from Covestro) were mixed with 1 weight-% of tetramethylammonium acetate in a 50 ml vial sealed with a teflon-equipped cap, the teflon is pierced with a needle in order to allow gas release. The vial was placed in a block reactor. Then, the reaction mixture was magnetically stirred for five hours at 100° C. After that, the reaction mixture was fully reacted and the resulting material could not be dissolved in an organic solvent. The ATR-FTIR spectrum of the resulting material showed a loss of NCO groups and the formation of isocyanurate groups (corresponding band at 1700 cm⁻¹). No presence of carbodiimide could be observed.

### Comparative Example 10: Preparation of a Polycarbodiimide Using a Secondary Diisocyanate (H₁₂MDI)

10 g of hydrogenated MDI (4,4′-diisocyanato dicyclohexylmethane, also designated as H₁₂MDI; Desmodur W from Covestro) were mixed with 1 weight-% of tributylmethylammonium 2-ethylhexanoate in a 50 ml vial sealed with a teflon-equipped cap, the teflon is pierced with a needle in order to allow gas release. The vial was placed in a block reactor. Then, the reaction mixture was magnetically stirred for 1.5 hours at 100° C. After that, the reaction mixture was fully reacted and the resulting material could not be dissolved in an organic solvent. The ATR-FTIR spectrum of the resulting material showed a loss of NCO groups and the formation of isocyanurate groups (corresponding band at 1700 cm⁻¹). No presence of carbodiimide could be observed.

### Comparative Example 11: Preparation of a Polycarbodiimide Using a Secondary Diisocyanate (H₁₂MDI)

10 g of hydrogenated MDI (4,4′-diisocyanato dicyclohexylmethane, also designated as H₁₂MDI; Desmodur W from Covestro) were mixed with 3 weight-% of tetrabutylammonium acetate in a 50 ml vial sealed with a teflon-equipped cap, the teflon is pierced with a needle in order to allow gas release. The vial was placed in a block reactor. Then, the reaction mixture was magnetically stirred for 2 hours at 100° C. After that, the reaction mixture was fully reacted and the resulting material could not be dissolved in an organic solvent. The ATR-FTIR spectrum of the resulting material showed a loss of NCO groups and the formation of isocyanurate groups (corresponding band at 1700 cm⁻¹). No presence of carbodiimide could be observed.

### Comparative Example 12: Preparation of a Polycarbodiimide Using a Secondary Diisocyanate (H₁₂MDI)

10 g of hydrogenated MDI (4,4′-diisocyanato dicyclohexylmethane, also designated as H₁₂MDI; Desmodur W from Covestro) were mixed with 3 weight-% of tetrabutylammonium 2-ethylhexanoate in a 50 ml vial sealed with a teflon-equipped cap, the teflon is pierced with a needle in order to allow gas release. The vial was placed in a block reactor. Then, the reaction mixture was magnetically stirred for 2 hours at 100° C. After that, the reaction mixture was fully reacted and the resulting material could not be dissolved in an organic solvent. The ATR-FTIR spectrum of the resulting material showed a loss of NCO groups and the formation of isocyanurate groups (corresponding band at 1700 cm⁻¹). No presence of carbodiimide could be observed.

### Example 13: Preparation of a Polycarbodiimide Using Tetrabutylammonium Acetate

10 g of tetramethylxylene diisocyanate (TMXDI; Allnex; 0.041 mol) were mixed with 0.1 g (1 weight-%) of tetrabutylammonium acetate in a 50 ml vial sealed with a teflon-equipped cap, the teflon is pierced with a needle in order to allow gas release. The vial was placed in a block reactor. Then, the reaction mixture was magnetically stirred and heated at 75° C. After approximately 8 hours the NCO content reached a value of 24.6% and the FTIR spectrum showed a strong band at 2100 cm⁻¹ corresponding to carbodiimide.

### Example 14: Preparation of a Polycarbodiimide Using Tetrabutylammonium Acetate

10 g of tetramethylxylene diisocyanate (TMXDI; Allnex; 0.041 mol) were mixed with 0.1 g (1 weight-%) of tetrabutylammonium acetate in a 50 ml vial sealed with a teflon-equipped cap, the teflon is pierced with a needle in order to allow gas release. The vial was placed in a block reactor. Then, the reaction mixture was magnetically stirred and heated at 125° C. After approximately 8 hours the NCO content reached a value of 16.7% and the FTIR spectrum showed a strong band at 2100 cm⁻¹ corresponding to carbodiimide.

### Example 15: Use of the Prepared Carbodiimides in Compounding with TPU

Three different thermoplastic polyurethane (TPU) compositions were prepared by hand cast procedure. A first TPU composition was prepared based on 4,4′-MDI (methylene Biphenyl diisocyanate), 1,4-butanediol/adipic acid polyester polyol (molar mass of 500 to 3000 g/mol), and 1,4-butanediol as chain extender; a second TPU composition was prepared based on 4,4′-MDI (methylene Biphenyl diisocyanate), 1,4-butanediol/1,2-ethylene glycol/adipic acid polyester polyol (molar mass of 500 to 3000 g/mol), and 1,4-butanediol as chain extender; a third TPU composition was prepared based on 4,4′-MDI (methylene Biphenyl diisocyanate), 1,4-butanediol/1,6-hexanediol/adipic acid polyester polyol (molar mass of 500 to 3000 g/mol) and 1,4-butanediol as chain extender; and a fourth TPU composition was prepared based on 4,4′-MDI (methylene Biphenyl diisocyanate), 1,2-ethylene glycol/adipic acid polyester polyol (molar mass of 500 to 3000 g/mol), and 1,4-butanediol as chain extender.

The TPU composition was prepared once without additional carbodiimide, once admixing 0.8 to 1.5 weight-% of a carbodiimide (relative to the amount of polyol) of the prior art, and once with admixing 0.8 to 1.5 weight-% of the inventive carbodiimide. In the cases of equipment with hydrolysis stabilizer, the carbodiimide was added to the pre-mixture of polyol and chain extender before the addition of the isocyanate in the hand cast procedure. The resulting TPU slaps for each composition were annealed at 110° C. for 3 h and then milled to granules. After drying, the granules were first injection molded to test specimens and then further annealed at 100° C. for 10 h. The hydrolysis stability of the TPU injection molding parts was evaluated by storage of S2 test specimen in water at 80° C. and subsequent periodical determination of the tensile strength (the tensile strength at the beginning, where t=0, was set to 100%).

TABLE 1
Tensile strength determined for the three test moldings based
on the first TPU composition for a time period of 56 days.

| | | Tensile | Tensile |
|---|---|---|---|
| | | strength | strength |
| | Tensile | of 1^{st} TPU | of 1^{st} TPU |
| | strength | composition | composition |
| | of 1^{st} TPU | with prior art | with inventive |
| | composition | carbodiimide | carbodiimide |
| t | without | prepared using | according to |
| [days] | carbodiimide [%] | MPO [%] | Example 1 [%] |
| 0 | 100 | 100 | 100 |
| 7 | 72 | 100 | 79 |
| 14 | 41 | 94 | 77 |
| 21 | 10 | 96 | 77 |
| 28 | 0 | 91 | 73 |
| 35 | | 89 | 71 |
| 42 | | 91 | 71 |
| 49 | | 82 | 71 |
| 56 | | 78 | 69 |

TABLE 2
Tensile strength determined for the three test moldings based
on the second TPU composition for a time period of 56 days.

| | | Tensile | Tensile |
|---|---|---|---|
| | | strength | strength |
| | Tensile | of 2^{nd} TPU | of 2^{nd} TPU |
| | strength | composition | composition |
| | of 2^{nd} TPU | with prior art | with inventive |
| | composition | carbodiimide | carbodiimide |
| t | without | prepared using | according to |
| [days] | carbodiimide [%] | MPO [%] | Example 1 [%] |
| 0 | 100 | 100 | 100 |
| 7 | 71 | 86 | 76 |
| 14 | 18 | 88 | 69 |
| 21 | 0 | 78 | 66 |
| 28 | | 82 | 72 |
| 35 | | 77 | 62 |
| 42 | | 67 | 52 |
| 49 | | 37 | 28 |
| 56 | | 8 | 0 |

TABLE 3
Tensile strength determined for the three test moldings based
on the third TPU composition for a time period of 56 days.

| | | Tensile | Tensile |
|---|---|---|---|
| | | strength | strength |
| | Tensile | of 3^{rd} TPU | of 3^{rd} TPU |
| | strength | composition | composition |
| | of 3^{rd} TPU | with prior art | with inventive |
| | composition | carbodiimide | carbodiimide |
| t | without | prepared using | according to |
| [days] | carbodiimide [%] | MPO [%] | Example 1 [%] |
| 0 | 100 | 100 | 100 |
| 7 | 63 | 88 | 92 |
| 14 | 19 | 84 | 89 |
| 21 | 0 | 88 | 89 |
| 28 | | 80 | 89 |
| 35 | | 74 | 89 |
| 42 | | 78 | 83 |
| 49 | | 78 | 83 |
| 56 | | 76 | 77 |

TABLE 4
Tensile strength determined for the three test moldings based
on the fourth TPU composition for a time period of 56 days.

| | | Tensile | | |
|---|---|---|---|---|
| | Tensile | strength | Tensile | Tensile |
| | strength | of 4^{th} TPU | strength | strength |
| | of 4^{th} TPU | composition | of 4^{th} TPU | of 4^{th} TPU |
| | composition | with prior art | composition | composition |
| | without | carbodiimide | with inventive | with inventive |
| t | carbodiimide | prepared using | carbodiimide | carbodiimide |
| [days] | [%] | MPO [%] | example 4 [%] | example 3 [%] |
| 0 | 100 | 100 | 100 | 100 |
| 7 | 70 | 77 | 100 | 100 |
| 14 | 27 | 77 | 100 | 100 |
| 21 | 0 | 77 | 100 | 81 |
| 28 | | 62 | 91 | 48 |
| 35 | | 15 | 55 | 15 |
| 42 | | 0 | 12 | 0 |

It can be gathered from the examples that a polycarbodiimide can be prepared under specific carbodiimidization conditions using a tertiary isocyanate, in particular a tertiary diisocyanate, and a specific catalytic material particularly comprising a specific cation, whereas it was not possible to prepare a polycarbodiimide using a different catalytic material. Further, it has been shown that applying different polymerization conditions or using different starting materials ac cording to the prior art also do not lead to a polycarbodiimide. In addition thereto, it has been shown that the prepared polycarbodiimide can be further subjected to end-capping for converting remaining isocyanate groups.

Further, it has been shown that a TPU composition prepared with admixing a polycarbodiimide according to the present invention shows a comparatively high durability determined by measuring the tensile strength after a water treatment compared to a TPU composition which does not include a hydrolysis stabilizer. In addition, a TPU composition prepared with admixing a polycarbodiimide according to the present invention even shows a superior durability compared with a TPU composition prepared with a prior art polycarbodiimide when a 1,4-butanediol/1,6-hexanediol/adipic ester polyester polyol was used as starting material for the TPU composition or when 1,2-ethylene glycol/adipic acid polyester polyol was used as starting material for the TPU composition.

### CITED LITERATURE

U.S. Pat. No. 3,345,407 A
U.S. Pat. No. 6,184,410 B1
WO 2016/202781 A1
EP 3766863 A1

1: A process for the preparation of a carbodiimide and/or a polycarbodiimide, the process comprising:
(i) providing a mixture comprising one or more tertiary isocyanates and a catalytic compound;
wherein the catalytic compound comprises a cation [R¹R²R³R⁴X]⁺,
wherein in the cation, X═N or P,
wherein R¹, R², R³, and R⁴ in the cation independently from one another is an optionally branched and/or optionally cyclic and/or optionally substituted alkyl, alkaryl, aralkyl, or aryl, wherein R¹ and R² optionally form an optionally heteroatom-containing ring, wherein R¹, R², and R³ optionally form two rings;
wherein the mixture obtained in (i) comprises equal to or less than 175 mol % of an alkali metal, calculated as elemental alkali metal, based on 100 mol-% of the one or more tertiary isocyanates, calculated as sum of the molar amounts of the one or more tertiary isocyanates; and
(ii) subjecting the mixture obtained in (i) to reaction conditions in a gas atmosphere, wherein the reaction conditions comprise heating the mixture at a temperature in the range of from 45 to 220° C.;
to obtain a mixture comprising the carbodiimide and/or polycarbodiimide.

2: The process of claim 1, wherein X═N in the cation comprised in the catalytic compound comprised in the mixture according to (i), and wherein the mixture obtained in (i) comprises equal to or less than 5 mol-% of a compound comprising a phosphorous oxygen double bond, calculated as molar amount of the compound comprising a phosphorous oxygen double bond, based on 100 mol-% of the one or more tertiary isocyanates, calculated as sum of the molar amounts of the one or more tertiary isocyanates.

3: The process of claim 1, wherein the catalytic compound further comprises one or more of a hydroxide anion and a carboxylate anion [R⁵—COO]⁻, wherein R⁵ in the carboxylate anion is hydroxyl (OH) or an optionally branched and/or optionally substituted (C₁-C₁₂)alkyl.

4: The process of claim 1, wherein X═N in the cation comprised in the catalytic compound comprised in the mixture according to (i).

5: The process of claim 4, wherein R¹, R², R³, and R⁴ in the cation comprised in the catalytic compound comprised in the mixture according to (1) independently from one another is selected from the group consisting of optionally branched and/or optionally cyclic and/or optionally substituted (C₁-C₂₂)alkyl, cycloaliphatic (C₅-C₂₀)alkyl, (C₆-C₁₈)aryl, (C₇-C₂₀)aralkyl, and (C₇-C₂₀)alkaryl.

6: The process according to claim 1, wherein the one or more tertiary isocyanates comprised in the mixture according to (1) comprises one or more tertiary monoisocyanates, one or more tertiary diisocyanates, or a mixture thereof.

7: The process according to claim 1, wherein the one or more tertiary isocyanates comprised in the mixture according to (1) comprises from 10 to 44 weight-% of NCO, based on 100 weight-% of the one or more tertiary isocyanates, calculated as sum of the weights of the one or more tertiary isocyanates.

8: The process according to claim 1, wherein a molar ratio of the one or more tertiary isocyanates comprised in the mixture according to (i), calculated as sum of the molar amounts of the one or more tertiary isocyanates, to the catalytic compound comprised in the mixture according to (1), calculated as molar amount of the cation comprised in the catalytic compound comprised in the mixture according to (i), in the mixture obtained in (i) is in the range of from to 0.5:1 to 100:1.

9: The process according to claim 1, wherein the mixture obtained in (i) is subjected to the reaction conditions in (ii) for a duration in the range of from 1 to 50 h.

10: The process according to claim 1, wherein the mixture obtained in (1) comprises the catalytic compound in an amount in the range of from 0.1 to 50 mol-%, based on 100 mol-% of the one or more tertiary isocyanates, calculated as sum of the molar amounts of the one or more tertiary isocyanates.

11: The process according to claim 1, further comprising:
(iii) subjecting the mixture obtained in (ii) to distillation conditions, wherein the distillation conditions comprise heating the mixture obtained in (ii) at the boiling point of the one or more tertiary isocyanates comprised in the mixture obtained in (ii) in a gas atmosphere; for separating at least a portion of the one or more tertiary isocyanates from the mixture.

12: The process according to claim 11, further comprising:
(iv) mixing the carbodiimide and/or polycarbodiimide obtained in (it) or (iii) with a second end-capping agent; and
(v) subjecting the mixture obtained in (iv) in a gas atmosphere to end-capping conditions, for obtaining a carbodiimide and/or a polycarbodiimide comprising one or more end-caps.

13: The process according to claim 12, wherein the second end-capping agent according to (iv) has the formula (IV):
HO—(R²⁵—O)ₙ—R²⁶ (IV),
wherein R²⁵ is an alkylene group,
wherein R²⁶ is an optionally partially unsaturated and/or optionally substituted alkyl group, and
wherein n is an integer of 0 to 150.

14: A carbodiimide and/or a poly carbodiimide, obtained and/or obtainable by the process according to claim 1.

15: A method, comprising:
stabilizing a polymer with the carbodiimide and/or polycarbodiimide according to claim 14.
